(19) United States
(12) Patent Application Publication
(10) Pub. No.: US 2025/0128695 A1
(43) Pub. Date: Apr. 24, 2025

(54) CONTROLLERS, METHODS, AND SYSTEMS FOR ENERGY SOURCE SELECTION

(71) Applicant: Cummins Power Generation Inc., Minneapolis, MN (US)

(72) Inventors: David P. Genter, Columbus, IN (US); Axel O. zur Loye, Columbus, IN (US); Andrew Guy Kitchen, Daventry (GB)

(73) Assignee: Cummins Power Generation Inc., Minneapolis, MN (US)

(21) Appl. No.: 18/922,279

(22) Filed: Oct. 21, 2024

Related U.S. Application Data
(60) Provisional application No. 63/592,807, filed on Oct. 24, 2023.

(51) Int. Cl. B60W 20/16; B60W 10/06; B60W 10/08

(52) U.S. Cl. CPC B60W 20/16; B60W 10/06; B60W 10/08; B60W 2510/244

(57) ABSTRACT

Emissions management is provided. A controller for vehicle energy source selection is configured to receive an indication of an emissions target for a vehicle. The vehicle includes one or more energy conversion devices. The one or more energy conversion devices are configured to generate mechanical movement from a first energy source and a second energy source. The controller is configured to receive an indication of a first emissions output corresponding to the first energy source. The controller is configured to receive a second emissions output corresponding to the second energy source. The controller is configured to select, based on the emissions target, the first emissions output, and the second emissions output, a first consumption rate for the first energy source and a second consumption rate for the second energy source.

### CROSS-REFERENCE TO RELATED PATENT APPLICATION

This application claims the benefit of U.S. Provisional Patent Application No. 63/592,807, filed Oct. 24, 2023, the entire disclosure of which is incorporated herein by reference.

### TECHNICAL FIELD

The present disclosure relates generally to energy consumption management. Some embodiments relate to emissions management of multiple energy source systems. Some embodiments relate to vehicles having multiple fuel sources that can receive electrical energy from an external device.

### BACKGROUND

Vehicles configured to reduce emissions can employ various strategies such as substitution of lower carbon content fuels (e.g., natural gas) or renewable fuels (e.g., hydro-treated vegetable oil (HVO)). Further, such systems can employ hybridization such as the inclusion of batteries to store electrical energy to replace or supplement an internal combustion engine, fuel cell, or other energy source.

### SUMMARY

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

In some aspects, the techniques described herein relate to a controller for energy source selection configured to: receive an indication of an emissions target for a vehicle, the vehicle including one or more energy conversion devices configured to generate mechanical movement from a first energy source and a second energy source; receive an indication of a first emissions output corresponding to the first energy source and a second emissions output corresponding to the second energy source; and select, based on the emissions target, the first emissions output, and the second emissions output, a first consumption rate for the first energy source and a second consumption rate for the second energy source.

In some aspects, the techniques described herein relate to a controller, further configured to: determine the first consumption rate for the first energy source, wherein the first energy source includes a first fuel and a second fuel; and determine the second consumption rate for the second energy source, wherein the second energy source includes a source for electrical energy, wherein a first energy conversion device of the one or more energy conversion devices: is configured to generate the mechanical movement from the first fuel and the second fuel; and is not configured to generate the mechanical movement from the electrical energy.

In some aspects, the techniques described herein relate to a controller, further configured to generate control signals configured to: cause the first energy conversion device to receive the first fuel at the first consumption rate; and cause the first energy conversion device to receive the second fuel at the second consumption rate.

In some aspects, the techniques described herein relate to a controller, wherein: the vehicle includes an alternator including a rotor, wherein the mechanical movement includes a movement the rotor, the alternator configured to provide electrical energy to propel the vehicle; and the controller is further configured to control a transfer of energy from an internal combustion engine of the one or more energy conversion devices to the alternator according to a quantity of fuel provided to the internal combustion engine.

In some aspects, the techniques described herein relate to a controller, further configured to: receive a route including: an indication of a grade for a plurality of route-segments; an indication of a load for the plurality of route-segments; and an indication of a distance for the plurality of route-segments; and determine, for each of the plurality of route-segments, a route plan including the first consumption rate and the second consumption rate such that: a summation of the first emissions output and the second emissions output for a first portion of the plurality of route-segments exceeds the emissions target; and a summation of the first emissions output and the second emissions output for the route plan does not exceed the emissions target.

In some aspects, the techniques described herein relate to a controller, further configured to: receive the emissions target from a second controller communicatively connected to a plurality of vehicles including the vehicle, the second controller configured to: determine, based on a total emissions target for the plurality of vehicles, the emissions target for the vehicle and a second emissions target for a second vehicle of the plurality of vehicles; and provide the emissions target to the vehicle, and the second emissions target to the second vehicle.

In some aspects, the techniques described herein relate to a controller, wherein: the first energy source includes a conductive element exterior to the vehicle for one or more route-segments of a route; and the controller is configured to receive, from the conductive element, a quantity of electrical energy during the one or more route-segments.

In some aspects, the techniques described herein relate to a controller, wherein: the first energy source includes an on-board fuel; and the controller is further configured to: detect a current state of fill of the on-board fuel; compare the current state of fill to a predefined state of fill; and select the first consumption rate and the second consumption rate based on the comparison of the current state of fill to the predefined state of fill.

In some aspects, the techniques described herein relate to a controller, further configured to select the first consumption rate and the second consumption rate to extend a distance traveled between refueling.

In some aspects, the techniques described herein relate to a controller, further configured to: discretize the distance traveled into one or more positions along a route to refuel the on-board fuel; and the extension of the distance terminates at one of the one or more positions.

In some aspects, the techniques described herein relate to a controller, further configured to select the first consumption rate and the second consumption rate, based on a remaining fuel level of the first energy source, to extend a time of operation for the vehicle.

In some aspects, the techniques described herein relate to a controller, further configured to: select, based on the emissions target, a fuel blend ratio between a plurality of mixable fuels, the plurality of mixable fuels including: a first fuel having a first carbon-intensity; and a second fuel having a second carbon-intensity less than the first carbon-intensity.

In some aspects, the techniques described herein relate to a controller, further configured to: receive an indication of an unavailability of the first energy source; select, based on the emissions target, a consumption rate of zero for the first energy source; and select, based on the emissions target, a non-zero consumption rate for the second energy source.

In some aspects, the techniques described herein relate to a controller, further configured to: receive an indication of a source of the first energy source; and select the first consumption rate based on the source.

In some aspects, the techniques described herein relate to a controller, further configured to: select the first emissions output for the first energy source based on the first energy source being a hydrocarbon fuel; and select the second emissions output for the second energy source based on the second energy source being a battery.

In some aspects, the techniques described herein relate to a method for vehicle energy source selection, the method including: determining a current state of fill of a fuel; receiving an indication of an emissions target for a vehicle, the vehicle including one or more energy conversion devices configured to generate mechanical movement from a plurality of energy sources including the fuel; receiving an indication of an emissions output for each of the plurality of energy sources; and adjusting, based on the emissions target, the current state of fill, and the emissions output for each of the plurality of energy sources, a consumption rate of the fuel.

In some aspects, the techniques described herein relate to a method, further including: determining a second consumption rate of a second fuel of the plurality of energy sources based on the emissions target, a state of fill of the second fuel, and a second emissions output for the second fuel; and determining a third consumption rate of electrical energy of a battery based on a state of charge (SoC) of the battery, wherein the adjustment to the consumption rate of the fuel is based on the second consumption rate and the third consumption rate.

In some aspects, the techniques described herein relate to a method, further including: determining the consumption rate of the fuel, the second consumption rate of the second fuel, and the third consumption rate of the electrical energy according to a local minimum of an objective function.

In some aspects, the techniques described herein relate to a method, further including: adjusting the consumption rate of the fuel based on a target life for the one or more energy conversion devices.

In some aspects, the techniques described herein relate to a system for energy source selection including: a controller including one or more processors coupled with memory, the controller couplable with an energy conversion device of a vehicle, the energy conversion device configured to generate mechanical movement from a plurality of fuels wherein the controller is configured to: receive an indication of an emissions target for the vehicle; receive an indication of a first emissions output corresponding to a first fuel of the plurality of fuels and a second emissions output corresponding to a second fuel of the plurality of fuels; and execute an objective function to select, based on the emissions target, the first emissions output, the second emissions output, and an operating parameter of the vehicle, a first consumption rate for the first fuel and a second consumption rate for the second fuel, wherein the operating parameter of the vehicle correlates negatively with a third emissions output for the vehicle.

In some aspects, the techniques described herein relate to a controller for energy source selection including one or more processors coupled with memory, the controller couplable with an energy conversion device of a vehicle, the energy conversion device configured to generate mechanical movement from a plurality of fuels wherein the controller is configured to: receive an indication of an emissions target for the vehicle; receive an indication of a first emissions output corresponding to a first fuel of the plurality of fuels and a second emissions output corresponding to a second fuel of the plurality of fuels; and execute an objective function to select, based on the emissions target, the first emissions output, the second emissions output, and an operating parameter of the vehicle, a first consumption rate for the first fuel and a second consumption rate for the second fuel, wherein the operating parameter of the vehicle correlates negatively with a third emissions output for the vehicle.

### BRIEF DESCRIPTION OF THE FIGURES

FIG. 1 is a block diagram of a vehicle including an energy conversion device configured to operate based on various fuels, according to some embodiments.

FIG. 2 is a route diagram, such as a route navigable by the vehicle of FIG. 1, according to some embodiments.

FIG. 3 is an energy flow diagram associated with a multi-fuel vehicle, according to some embodiments.

FIG. 4 is an intensity-production diagram for a multi-fuel vehicle, according to some embodiments.

FIG. 5 is a user interface depicting various vehicles of a facility, according to some embodiments.

FIG. 6 is a block diagram of a vehicle including an energy conversion device configured to operate based on various fuels, according to some embodiments.

FIG. 7 is a depiction of a vehicle traversing a route, according to some embodiments.

FIG. 8 is a block diagram illustrating an architecture for a computer system that can be employed to implement elements of the systems described and illustrated herein, according to some embodiments.

FIG. 9 is a flow chart illustrating a method for vehicle energy source selection, according to some embodiments.

FIG. 10 is a block diagram of a controller for vehicle energy source selection, according to some embodiments.

FIG. 11 is a flow chart illustrating a method for vehicle propulsion, according to some embodiments.

### DETAILED DESCRIPTION

Following below are more detailed descriptions of various concepts related to, and implementations of systems including a multi-fuel engine. Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Various implementations of the present disclosure relate to apparatus (e.g., controllers), systems, and methods for propulsion of vehicles and/or selecting energy sources and/or consumption rates of energy sources of vehicles. According to various embodiments of the present disclosure, vehicles can include various energy sources, such as fuels and electric energy sources. Fuels can include fuel blends (e.g., blends of petroleum diesel, biodiesel, or hydrotreated vegetable oil). Some fuels can be stored or received separately (e.g., in separate reservoirs or fuel ports), such as natural gas, employed in combination with a diesel adjacent fuel. Various fuels can correspond to a respective emissions output, which may relate an energy produced by the fuel to an amount of emissions associated with the combustion, processing, or transportation of the fuel. Electrical energy sources can include electrical ports such as ports configured to receive energy at a halt from a fixed charging station, or while traversing a route, such as from a pickup shoe or pantograph.

A controller for vehicle energy source selection can be configured to perform various operations. Particularly, the controller receives an indication of an emissions target for a vehicle. The vehicle includes one or more energy conversion devices. The energy conversion devices are configured to generate mechanical movement from a first energy source and a second energy source. In some embodiments, the energy conversion devices can generate mechanical movement from any number of energy sources. For example, the energy conversion devices can include an engine assembly configured to generate mechanical movement from any number of fuels (e.g., fuel blends). In some embodiments, the energy conversion devices can include an electric motor to generate the mechanical movement. The controller receives an indication of a first emissions output corresponding to the first energy source. The controller receives an indication of a second emissions output corresponding to the second energy source. In various embodiments, the controller receives an indication of further emissions outputs corresponding to any number of further energy sources. The controller is configured to select the first emissions output and the second emissions output. The controller is configured to select a first consumption rate for the first energy source and a second consumption rate for the second energy source. The selections can be based on the emissions target.

In some embodiments, vehicles can include an electrical port to interface with an external conductive element, such as a conductive element extending along a route (e.g., a portion thereof). For example, the conductive element can include a catenary line, third rail, or so forth. A system to generate mechanical energy for propulsion of the vehicle can include an electrical port. The electrical port is configured to receive electrical energy from the conductive element, exterior to the vehicle. The vehicle further includes an energy conversion device. The energy conversion device can include a combustion engine or fuel cell, which can receive various fuels. Particularly, the energy conversion device receives at least a first fuel and a second fuel. The system includes a vehicle controller configured to determine a first consumption rate of the first fuel and a second consumption rate of the second fuel. The determination can be based on an energy demand. For example, the energy demand can be according to a user input (e.g., accelerator position), autonomous system, a predefined route (e.g., an estimation thereof), or so forth. In some embodiments, the apportionment of the energy demand is between any number of fuels. In some embodiments, the consumption rate can be based on an apportionment of the energy demand between the fuels, and electrical energy sourced from the electrical port. In some embodiments, the apportionment can be time variant. For example, consumption rates can vary according to a predefined route, such as a route including some portions having a conductive element to provide electrical energy to the vehicle, and some portions which do not. Other time-variant examples include routes where a vehicle is loaded for a first portion and not for a second portion, or routes associated with changing grades.

Hybridization or substitution can include considerations (e.g., criteria) beyond lowering of emissions. For example, emissions management can be implemented to maintain a level of productivity in excess of other approaches, maintain a degree of non-fungibility between feedstocks and energy production, or maintain energy availability. Further, such considerations may vary between operating sites, over time, between various vehicles, or according to a value or type of an emissions target. In some embodiments, a system can employ an objective function to determine an absolute or local minimum associated with various considerations. The objective function can satisfy (e.g., not exceed), at least in the aggregate, an emissions threshold. A system can select a consumption rate for various fuels based on a quantity of electrical energy received from a catenary line or other electrical source disposed along a route. The selected fuels can be selected to apportion an emissions target therebetween.

In some embodiments, the system includes a route planner to determine any of a fuel mix, operating speed, loading weight, or other operational parameters for one or more vehicles, to satisfy an emissions target for the one or more vehicles. The system can apportion a target between various vehicles at a site to generate constituent emissions targets for the vehicles, so as to manage emissions on a site-basis rather than a vehicle-by-vehicle basis, which may better modulate productivity or reduce emissions. The system can determine routes based on various site equipment, such as a location or rate of energy provided by fueling stations or electric charging stations (e.g., stationary charging stations, or electrified elements coupled to a pantograph or pickup shoe of a vehicle). For example, the systems can determine a route based on a refueling time or location of one or more vehicles (e.g., a vehicle may operate at a reduced speed to extend a refuel/recharge event). Further, the system can determine a change to a vehicle, site infrastructure, or other equipment, to better satisfy the objective function.

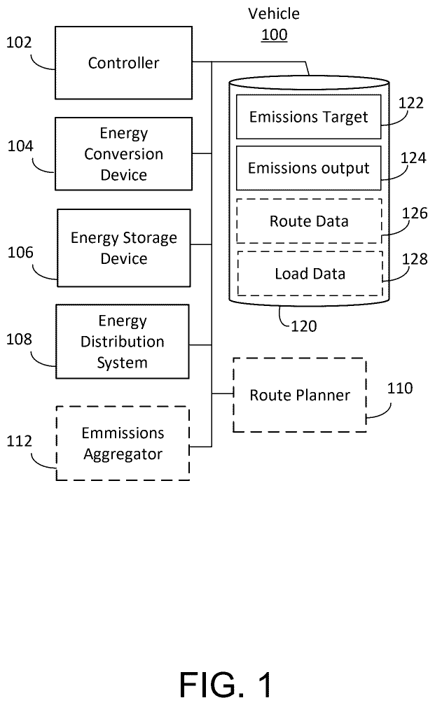

As shown in FIG. 1, a controller 102 for energy source selection is provided. The controller 102 is configured to receive an indication of an emissions target 122 for a vehicle 100. The vehicle 100 includes one or more energy conversion devices 104. The one or more energy conversion devices 104 are configured to generate mechanical movement from a first energy source and a second energy source. The controller 102 is configured to receive an indication of a first emissions output 124 corresponding to the first energy source. The controller 102 is configured to receive a second emissions output 124 corresponding to the second energy source. The controller 102 is configured to select, based on the emissions target 122, the first emissions output, and the second emissions output 124, a first consumption rate for the first energy source and a second consumption rate for the second energy source.

In some embodiments, the controller 102 is a controller 102 of a system, such as an engine control system or vehicle emissions control system. The system can include any of the components disclosed herein. For example, the system can include the one or more energy conversion devices 104 operatively coupled with the controller 102. The system can include one or more energy storage devices 106 operatively coupled with the controller 102.

In some embodiments, the controller 102 executes operations to manage the performance of the systems and methods described herein. For example, the vehicle 100 includes or interfaces with an energy storage device 106 to maintain a store of an energy source, such as a fuel source or electrical energy. In some embodiments, the vehicle 100 includes or interfaces with a route planner 110 to determine attributes of a route traversed by the vehicle 100, or operations of the vehicle 100 along the route. In some embodiments, the vehicle 100 includes or interfaces with an emissions aggregator 112 to determine an apportionment of energy between various energy sources or sinks, such as vehicles, infrastructure, or other equipment relevant to one or more routes. In some embodiments, the first energy source includes a first fuel and a second fuel. The controller 102 can determine a first consumption rate for the first energy source based on the first energy source including the first fuel and the second fuel. The second energy source can include a source for electrical energy. The controller 102 can determine a second consumption rate for the second energy source based on the second energy source including the electrical energy. A first energy conversion device of the one or more energy conversion devices can be configured to generate the mechanical movement from the first fuel and the second fuel (e.g., can be an engine assembly). In some embodiments, the first energy conversion device is not configured to generate the mechanical movement from the electrical energy. The controller 102 can receive an indication of a source of the first energy source, and select the first consumption rate based on the source.

The vehicle 100 can be any type of on-road or off-road vehicle 100 including, but not limited to, wheel-loaders, fork-lift trucks, line-haul trucks, mid-range trucks (e.g., pick-up truck, etc.), sedans, coupes, tanks, airplanes, boats, and any other type of vehicle. For example, the vehicle 100 can be a locomotive or mining haul truck configured to travel along a fixed path of travel. The vehicle 100 can be operated by an occupant thereof, an operator remote therefrom, or may be an autonomous vehicle 100 (e.g., fully autonomous or partially autonomous).

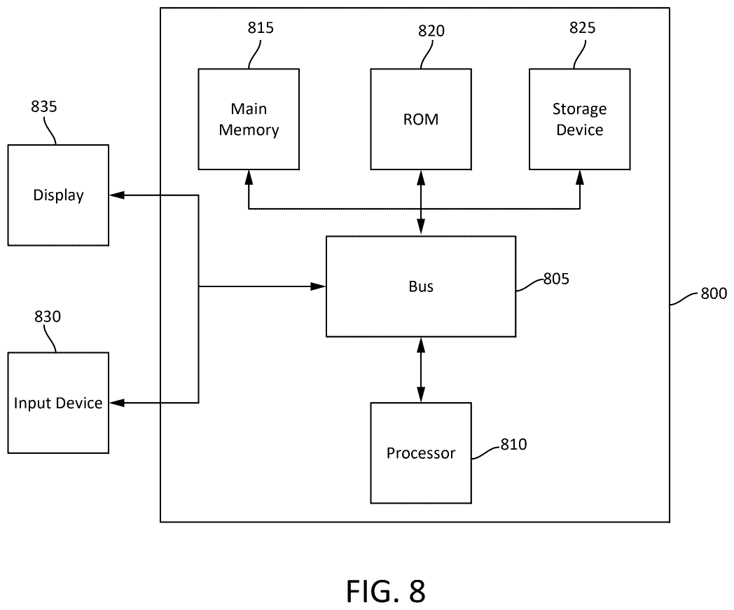

The controller 102, energy conversion device 104, energy storage device 106, energy distribution system 108, route planner 110, or emissions aggregator 112 can each include or interface with at least one processing unit or other logic device such as a programmable logic array engine, or module configured to communicate with a data repository 120 or database. The controller 102, energy conversion device 104, energy storage device 106, energy distribution system 108, route planner 110, emissions aggregator 112, or data repository 120 can be separate components configured to interface with the vehicle 100, a single component, or part of the vehicle 100. For example, a remote device (e.g., server complex) can include the energy distribution system 108, route planner 110, or emissions aggregator 112, and can be configured to interface, over a network, with the vehicle 100. The vehicle 100, remote from the remote device, can include an energy conversion device 104, energy storage device 106, and energy distribution system 108. The controller 102 can include one or more processors disposed locally on the vehicle 100, and one or more processors of the remote device. Either of the one or more processors may also be referred to, separately, as a controller 102 (e.g., as a first controller 102 and a second controller 102). The various components of the vehicle 100, or interfacing therewith, can include hardware elements such as one or more processors, logic devices, or circuits. For example, the vehicle 100 can include one or more components or structures of functionality of computing devices depicted in FIG. 8.

The data repository 120 can include one or more local or distributed databases, and can include a database management system. The data repository 120 can include computer data storage or memory and can store one or more of an emissions target 122, an emissions output 124, route data 126, or load data 128. The emissions target 122 can refer to or include a target for emissions of one or more pollutants or combustion products. References to emissions can include carbon emissions, but are not limited thereto; references to carbon are intended as illustrative, non-limiting examples. That is, the various references to CO₂ may be substituted or complemented by other greenhouse gasses such as N₂O or CH₄, or NO_{X}, particulate matter (PMX), sulfur dioxide (SO₂), volatile organic compounds (VOCs), etc.

The emissions target 122 can refer to or include a periodic emissions target 122 (e.g., daily or monthly). The emissions target 122 can be relative to an amount of energy produced (e.g., 0.5 tons/MWh). The emissions target 122 can refer to an emissions quantity corresponding to a traversal of a route or segment thereof. The emissions target 122 can be based on another metric (e.g., ton-miles transported, tons of production, tons of ore extracted, passengers transported, or so forth).

The emissions target 122 can be or include various lifecycle portions. For example, the emissions target 122 can include a tank-to-wheel target, for emissions released from an engine assembly of the vehicle 100 during operation. That is, the emissions target 122 can relate to tailpipe emissions from a vehicle 100. A tank-to-wheel emissions target 122 (or portion thereof) may thus exclude emissions in the extraction, refinement, or transportation of a fuel. Further, tank-to-wheel emissions targets 122 may not, on their own, adjust for a contribution of green fuels such as renewable biodiesel, or diesel generated according to a Fischer-Tropsch process. In some instances, a tank-to-wheel emissions target 122 can be employed alone. However, in many instances, a tank-to-wheel emissions target 122 can be an intermediate target used to calculate another emissions target 122, or be based on another emissions target 122.

The tank-to-wheel emissions target 122 can be based on, or apportioned from, a direct carbon-intensity based emissions target 122. For example, the direct carbon-intensity emissions target 122 can be set at 1 arbitrary unit for petroleum diesel. Continuing the example, for a blended fuel (e.g., B50, including 50% petroleum diesel and 50% renewable biodiesel), the tank-to-wheel emissions target 122 can be established at 2 of the arbitrary units.

A tank-to-wheel emissions target 122 can depend upon other energy sources, such as electrical energy provided via an electrical port of an electric vehicle, such as a plug-in hybrid electric vehicle 100 (PHEV). In some instances, the emissions target 122 can be or include components of a well-to-wheel emissions target 122, to further include contributions of various energy sources such as an indirect carbon-intensity based emissions target 122. For example, an emissions contribution related to transportation, extraction, refinement, or other emissions incident to providing an energy source to the vehicle 100. Moreover, in some instances, more than one emissions target 122 may exist. For example, a well-to-wheel emissions target 122 may coexist with a tank-to-wheel emissions target 122, in order to meet standards which have not been homologated by a same body. That is, in some embodiments, the systems and methods herein can operate simultaneously according to various emissions targets 122.

The emissions output 124 can include or refer to any indication of an emissions output 124. The emissions output 124 can be based upon an amount of fuel or other energy source added to a vehicle 100 or other equipment, an amount of fuel passed through a fueling system, or so forth. The emissions output 124 can depend on various information associated with a fuel according to one or more emissions targets 122. For example, the emissions output 124 of a blend may or may not vary according to a source thereof, thus the controller 102 can receive an indication of a source incident to refueling, to determine an emissions output 124 relative to an emissions target 122. Some emissions outputs 124 can be based an application of emissions credits, or may disregard or discount such credits. For example, the emissions targets 122 can apply a first emissions credit type, apply a second emissions credit type at a reduced value (e.g., 50%), or disregard an emissions credit. The controller 102 can receive an indication of a source of the first energy source.

An emissions output 124 can be associated with a carbon-intensity of a fuel. For example, a specific emissions output 124 for grid-based electricity, photovoltaic derived electricity, diesel, and H₂ can be received, such that the controller 102 can select a consumption rate for the fuel based thereupon. For example, the energy distribution system 108 or route planner 110 can apportion energy based upon a demand associated with a route-portion (e.g., based on a target speed, emissions target 122, or so forth).

The route data 126 can correspond to any number of route-segments which may be defined discretely, or which may be derived from any fractional portion of a route. That is, the controller 102 can discretize the distance traveled into one or more positions along a route associated with an on-board fuel. A route can be apportioned into any number of route-segments which may, in turn, each be apportioned into any number of route-segments themselves. A route-segment can be associated with a grade, material, or feature. For example, a route-segment can include a paved portion, an unimproved portion, or a portion having a third rail, catenary line, or other conductive element available to the vehicle 100. A route-segment can be associated with a function relevant to emissions. For example, a route-segment can be associated with an empty or loaded vehicle, as in the case of an ore extraction site where vehicles 100 generally transit to such a site unloaded, and return from such a site loaded.

Route data 126 can include elevation, temperature or other climatic information which corresponds to emissions output 124 (e.g., a vehicle 100 ascending a wet rail or roadway may be limited by tractive force, and may thus lower an absolute emissions output 124, but may raise an emissions output 124 according to another metric, such as a per ton-mile metric). Route data 126 can include speed restrictions or typical speeds, noise emission restrictions, or other information relevant to determining an emissions output 124. Route data 126 can include an indication of one or more energy sources disposed along the route, such as an electric charging station, fuel point, or so forth, which is relevant to operation of the vehicle 100.

The load data 128 can include information of a load borne by the vehicle. The load data 128 can be received by a load interface such as an automated load interface (e.g., a stress/strain sensor associated with a cargo area of the vehicle 100). In some instances, the load interface is a user interface accessed by an occupant of the vehicle 100 or a remote user who can provide a load borne by the vehicle. In some instances, load data 128 is determined based on an amount of an energy source consumed, such as a depletion of a fuel reservoir or a battery state of charge (SoC). In some instances, load data 128 is determined according to historical information. For example, for a mining vehicle 100 which transits a predefined route with a same or similar load, the load data 128 can include a predefined indication of an average, typical, maximum, or other characteristic of a load, such as the weight thereof.

Referring further to FIG. 1, the vehicle 100 can include or interface with at least one controller 102. The controller 102 can include or interface with one or more processors and memory. The processor can be implemented as a specific purpose processor, an application specific integrated circuit (ASIC), one or more field programmable gate arrays (FPGAs), a group of processing components, or other suitable electronic processing components. The processors and memory can be implemented using one or more devices, such as devices in a client-server implementation. The memory can include one or more devices (e.g., random access memory (RAM), read-only memory (ROM), flash memory, hard disk storage) for storing data and computer code for completing the various operations described herein. The memory can be or include volatile memory or non-volatile memory and can include database components, object code components, script components, or any other type of information structure for supporting the various activities and information structures of the present disclosure. The memory can be communicably connected to the processor and include computer code or instruction modules for executing one or more processes described herein. The memory can include various circuits, software engines, and/or modules that cause the processor to execute the systems and methods described herein.

The controller 102 can include or be coupled with communications electronics. The communications electronics can conduct wired and/or wireless communications. For example, the communications electronics can include one or more wired (e.g., Ethernet, PCIe, AXI, or CAN) or wireless transceivers (e.g., a Wi-Fi transceiver, a Bluetooth transceiver, an NFC transceiver, or a cellular transceiver). The transceivers can operatively couple the various processors of the controller 102, or between the controller 102 and other devices. The controller 102 can cause one or more operations disclosed, such as by employing another element of the vehicle 100. For example, operations disclosed by other elements of the vehicle 100, or described without specific reference to a component can be initiated, scheduled, or otherwise controlled by the controller 102. Moreover, operations performed by the controller 102 can refer to, in some instances, operations performed by the one or more processors of the controller 102, and in some further instance, operations performed by various elements, responsive to control signal generated by the controller 102. This disclosure may refer to generation of these control signals according to, for example, explicit mention of the control signals, references to the controller 102 causing an action, or otherwise referring to actions performed by the controller 102 involving further devices.

The controller 102 is structured to control, at least partly, the operation of the energy conversion device 104 and associated systems, such as the energy storage device 106. Communication between and among the components can be via any number of wired or wireless connections. In some embodiments, a controller area network (CAN) bus provides the exchange of signals, information, and/or information. The controller 102 can be, include, or interface with one or more electronic control units (ECU). Because the controller 102 is communicably coupled to at least some of the systems and components of FIG. 1, the controller 102 is structured to receive information from one or more of the components shown in FIG. 1.

The vehicle 100 includes at least one energy conversion device 104. The energy conversion device can generate mechanical movement from a fuel or other energy source. The mechanical movement can propel the vehicle. In some embodiments, the mechanical movement can propel the vehicle through mechanical intermediaries, such as gears, differentials, and wheels. In some embodiments, the mechanical movement can include a movement of a rotor of an alternator of the vehicle (e.g., based on the movement of a crankshaft). The controller 102 can control a transfer of energy from an internal combustion engine or other fuel consuming engine to the alternator according to a quantity of fuel provided to the internal combustion engine. For example, the controller 102 can generate control signals for a pump, valve, or injector of the internal combustion engine. The alternator can be configured to provide electrical energy to propel the vehicle. The propulsion can be via one or more electric motors. The energy conversion device 104 can be or include an electrically powered motor, a fuel cell, or an engine assembly which consumes one or more fuel sources. In some embodiments, the engine assembly is coupled to an alternator to generate electrical energy. In some embodiments, the engine assembly or the electric motor is mechanically coupled to one or more mechanical elements such as a differential, gear, or other component configured to cause a propulsion of the vehicle 100.

Various fuels or portions thereof can have different properties and/or chemical compositions. The properties can include auto-ignition temperatures, flame speeds, etc. The fuels can include diesel and natural gas, for example. For example, the fuel can include any of diesel fuel, natural gas (e.g., compressed natural gas (CNG), liquefied natural gas (LNG)), an e-fuel, alcohol fuels such as ethanol or methanol, or liquid biofuel. The liquid biofuel can be methanol and/or ethanol, for example. The first fuel or the second fuel can be any one of a high cetane number fuel, such as diesel, gas-to-liquid (GTL) diesel, heavy fuel oil (HFO), low sulfur fuel oil (LFSO), hydrotreated vegetable oil (HVO), marine gas oil (MGO), renewable diesel, biodiesel, paraffinic diesel, dimethyl ether (DME), F-76 fuel, F-34 fuel, jet A fuel, JP-4 fuel, JP-8 fuel, or oxymethylene ether (OME), or a low cetane number fuel (e.g., a high octane number fuel, a high methane number fuel). The low cetane number fuel can be natural gas, hydrogen, ethane, propane, butane, syngas, ammonia, methanol, ethanol, or gasoline. It should be appreciated that the foregoing are merely examples of fuels, and other types of first and second fuels are not precluded.

The various liquid or gaseous fuels can be provided from various sources, which may be associated with different emission levels. For example, hydrogen can include “green” hydrogen, produced via electrolysis from renewable sources, or “gray” hydrogen, formed from steam methane reforming. The controller 102 can receive the source information. The source information can include an indication of transportation or other emissions contributions. For example, a locally sourced or pipeline-transported fuel may be associated with a lower carbon intensity than foreign sourced or truck transported fuel.

The controller 102 can receive an indication of the sourcing of various fuel or other energy sources. Sourcing information can also include emissions credits associated with fuels. The controller 102 can apply all or a portion of emissions associated with a sourced fuel or other energy sources. The various emissions credits can include emission credits which may be applied, discounted, or disregarded, according to various emissions targets 122.

The energy conversion device 104 can be a component of a propulsion unit including an electric motor (e.g., traction motor) to generate or apply a tractive force to a road, rail, or other surface. The electric motor can receive electrical energy from an alternator, mechanical energy from a movement of the vehicle, or so forth, and cause wheels, tracks, propellers, etc. to interface with a surface or fluid to propel the vehicle. In some instances, the electric motor can receive energy from an energy source other than the engine assembly. For example, an electric motor can receive energy from a battery or capacitor bank (e.g., supercapacitor) of a hybrid vehicle 100 to propel the hybrid vehicle 100. Such an example includes either of a vehicle 100 having a same electric motor to receive electrical energy from the engine assembly (via an alternator) and electrical energy from the battery, or a vehicle 100 receiving electrical energy at a first electric motor (e.g., an electric assist motor), and energy derived from the engine assembly at a second electric motor.

The propulsion unit can include a fueling system to provide fuel to the energy conversion device 104. The fueling system can operate based on control signals generated by the controller 102. For example, the fueling system can receive control signals, generated by the controller 102, to cause the energy conversion device 104 to receive various fuels at various consumption rates (e.g., cause the first energy conversion device to receive the first fuel at the first consumption rate and cause the first energy conversion device to receive the second fuel at the second consumption rate). The fueling system can receive energy from a refueling point for one or more fuels. The vehicle 100 can receive electrical energy from a charging station such as a fixed charging point or a conductive element exterior to the vehicle 100 extending along a route-segment, such as a third rail or catenary line. That is, a first energy source can include a conductive element exterior to the vehicle for one or more route-segments of a route. The controller can receive, from the conductive element, a quantity of electrical energy during one or more of the route segments (e.g., generate control signals to cause an energy conversion device 104 or energy storage device 106 to receive the energy). An electrical energy source can include an on-board energy source such as an ammonia cracker, regenerative traction motor, flywheel, fuel cell, etc. The electrical energy can be provided to an energy storage device 106 (e.g., battery), a traction motor, or other vehicle systems.

The fueling system can provide one or more fuels to the engine assembly. For example, the fuel system can provide one or more fuels such as petroleum diesel, HVO, biodiesel, or a blend thereof via a first fueling system including a fuel reservoir, fuel lines, injectors, or other components. The fuel system can provide another fuel such as hydrogen, natural gas, alcohols such as methanol or ethanol, or ammonia via a second fueling system which can include a second fuel reservoir, fuel lines, injectors, or other components, at least some of which are separate from the first fueling system. Some fuel systems can include a diesel or diesel-adjacent fuel as a priming fuel, and another fuel as a substitution fuel, such that a substitution rate is selected according to a load demanded, or an emissions target 122. Some systems can operate without a priming fuel, which employ a combination of fuels based on an energy-intensity and carbon-intensity variance between the fuels (e.g., to substitute a less energy-intense fuel at low-loads). Various energy conversion devices 104 can receive energy from various combinations of energy sources, such as any electrical sources in combination with one or more fueling systems (e.g., the first or second fueling systems described above).

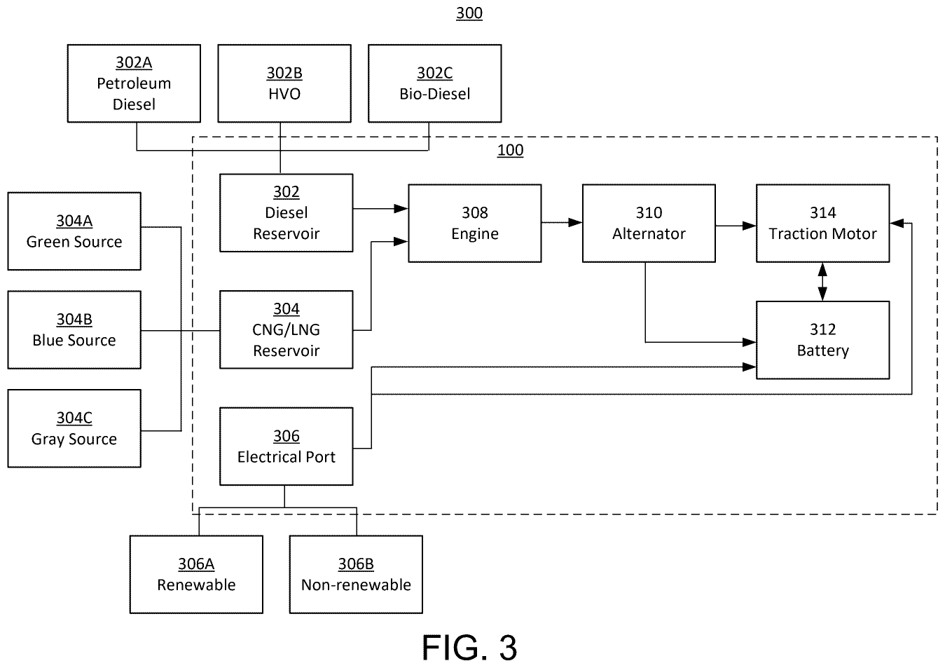

The vehicle 100 can include at least one energy storage device 106. An energy storage device 106 can include a battery, super capacitor, or the like to store electrical energy. A sensor (e.g., a voltage sensor, current sensor, etc.) can determine a battery state of charge (SoC). A sensor, memory device, or combination thereof can determine a state of health of the battery. For example, a memory device can store a count of charge/discharge cycles, times, or total expended energy. A sensor can determine a temperature, voltage-current relationship, or other information associated with the battery. The battery can be integral to the vehicle 100 or configured for removal, to swap between a charged and discharged battery. The energy storage device 106 can include a reservoir to store a hydrocarbon or other fuel (e.g., diesel, H₂, or CNG). The reservoir can include a fuel sensor such as a float, capacitive, pressure, or other sensor to determine a quantity of fuel in the reservoir. The various sensors associated with the energy storage devices 106 can be communicatively coupled to the controller 102 and configured to convey an indication of the energy stored therein (e.g., based on a quantity of fuel or a SoC). The operation of the vehicle 100 can include various transfers of energy between the energy storage devices 106, which is further described with regard to the energy flow diagram of FIG. 3.

The vehicle 100 can include or interface with at least one energy distribution system 108. The energy distribution system 108 can receive an indication of an emissions target 122 (e.g., a carbon-intensity demand), speed demand, or an energy demand. The energy distribution system 108 can receive emissions outputs 124 associated with the various energy sources. The energy distribution system 108 can apportion energy sourced between various energy sources based on the emissions target or the energy demand, or otherwise select consumptions rates for the various energy sources based on the emissions target 122 and the emissions outputs 124. In some embodiments, the demand is received from a vehicle control system, such as according to a user input (e.g., throttle petal, or vehicle autonomy system). In some embodiments, the demand is received from a route planner 110, the energy demand corresponding to various route-segments. The route-segments of the route may be of a defined length, or can be iterative (e.g., the segments can be a distance traveled per feedback-loop cycle time of the energy distribution system 108 or route planner 110).

The energy distribution system 108 modulates between the various energy sources (e.g., a first fuel source can include a hydrocarbon fuel and a second fuel source can include a battery). For example, the energy distribution system 108 can determine a fuel mix to achieve the demand. The controller 102 can select the first emissions output for the first energy source comprising the hydrocarbon fuel and the second emissions output for the second energy source comprising a battery. The fuel mix can be a mix of diesel, CNG, or other fuels, and be provided along with a portion of energy sourced from stored electrical energy or electrical energy available along a route. The energy distribution system 108 can prioritize fuel according to an emissions output 124 associated therewith. For example, the energy distribution system 108 can implement or determine an objective function associated with the operation of the vehicle to meet an energy, speed, or other demand. An example of an objective function is provided hereinafter, with regard to the route planner 110. In some embodiments, the energy distribution system 108 can implement an objective function based on the received indication of the emissions target 122 and emissions outputs associated with the various vehicle energy sources (e.g., without regard to a predefined route). In some embodiments, the energy distribution system 108 can receive an energy demand based on an output of an objective function of the route planner 110. For example, the route planner 110 can receive the indication of the emissions target 122, and provide an energy demand to the energy distribution system 108 based on the emissions target 122, and an emissions output associated with the various energy sources associated with the energy distribution system 108.

In an illustrative example, the electric energy of the battery can be a net-zero emission source, the CNG can be associated with 300 kg/MWh, and a B20 diesel blend can be associated with 600 kg/MWh. For an energy demand of 1000 kW, the energy distribution system 108 can apportion energy in the battery in excess of a minimum threshold, such as to provide an average of 100 KW for a segment. The energy distribution system 108 can determine a maximum CNG substitution rate to generate the remaining portion (e.g., 900 kW). Similarly, in a speed demand system, the energy distribution system 108 can apportion the electrical energy, and determine a substitution rate between fuels to reach the speed.

In some instances, the energy distribution system 108 can receive or define a state demand of the vehicle 100 at a point along a route (e.g., at a terminal portion of a route-segment). For example, a route can include a change in grade, such that a minimum threshold of the battery may be fully charged, or another non-zero SoC, to maintain a target speed ascending a grade. Conversely, when approaching a portion of a route including an electrified third rail, or a downward grade in a vehicle 100 including regenerative braking, the energy distribution system 108 can determine or receive an instruction (from the route planner 110) that the battery should be brought to depletion when approaching the segment, to increase opportunistic charging. Other state demands can include, without limitation, minimum or maximum speed restrictions, noise restrictions, weight restrictions, tractive force restrictions, emissions restrictions for one or more emissions (e.g., NO_{X} or PMX), or so forth.

In some embodiments, the vehicle 100 includes or interfaces with at least one route planner 110. The route planner 110 can receive, generate, store, or convey a route for the vehicle 100. The route can include any of a path of travel, speed, carbon-intensity, energy use, load data 128, refueling or recharging stops, or threshold for a state of charge of an energy storage device 106 along a route-segment. For example, the controller 102 can be configured to receive a route. The route can include an indication of a grade for various route-segments, an indication of a load for various route-segments, or an indication of a distance for various route-segments. The route planner can 110 can determine a route plan including a consumption rate for various fuels (e.g., a first fuel and a second fuel) or other energy sources. A summation of the emission outputs 124 for the various fuels can be equal to or less than an emission target 122. The emissions target 122 may be provided according to a same unit as the emission outputs 124, such that the emissions target 122 and the emission outputs 124 may be compared (e.g., tons CO₂ or CO₂ equivalent). However, such a summation can vary over various route segments, such that one route-segment may exceed a corresponding emissions target 122. For example, a vehicle 100 can reduce emissions while loading or unloading (e.g., a truck at a loading dock or a train at a station).

The route planner 110 can receive an indication of an emissions target 122 associated with the route. The route planner 110 can receive an indication of an emissions output 124, such as a historical emissions output, or an output associated with various energy sources. The route planner 110 can select, based on the emissions target 122 and emissions output 124, a consumption rate for the various energy sources (e.g., modulate therebetween).

The route planner 110 can ingest a route according to various input sources. For example, the route planner 110 can receive an explicit input of load data 128 or predefined path of travel, along with any speed restrictions (maximums or minimums), or other route data 126. The route planner 110 can ingest historical route data 126 and determine a path of travel, along with engine loading, load data 128, or other route data 126. The path of travel can include a fixed path of travel such as a path of a locomotive along fixed rails. The path of travel can include another route, such as a mining haul truck traveling between a sourcing and receiving location, a route traversing public roads (e.g., according to traffic conditions, road closures weather, or tunnel operation), or a ferry navigating between an origin and destination point. A route can include variances to speeds traveled, loaded weight, or a path of travel. The route planner 110 can determine an average, maximum, or other feature of the route (e.g., distance, propulsion system load, etc.) along with a variance associated with the route.

The route planner 110 can implement or determine an objective function associated with the operation of the vehicle 100 along the route, based on the route data 126. For example, the objective function can include a binding or soft constraint of the emissions target 122, and a given parameter corresponding to a value ascribed to the movement of a load of the vehicle 100 (e.g., a ton-mile value, completed trip value, or so forth). The route planner 110 can determine one or more solutions (e.g., local minimums) to satisfy the objective function. For example, the objective function can be described according to ‘T,’ a number of trips, ‘E,’ emissions per trip, ‘F,’ fuel consumption per trip (e.g., F₁, F₂, F₃, corresponding to the various fuels or other energy sources), ‘B,’ battery charging time, and ‘S,’ fuel substitution rate. An objective function, C, can be expressed as, for example, C(T, E, F, B, S)=w₁(T)−w₂E(T, F, S)+w₃B(T, S). The constituent functions can refer to, respectively, a first weight, w₁ ascribed to a number of trips; a second weight, w₂ ascribed to a change of emissions based on changes to consumption rates of the various fuels, and a third weight, w₃. ascribed to the battery charging time which may vary according to the number of trips and fuel use.

The provided objective function is not intended to be limiting. For example, further terms can correspond to battery health or other equipment lifing or maintenance, a number of total or sequential hours an operator is present with the vehicle (e.g., labor intensity), or so forth. Equipment lifing can refer to or include a determination of a predicted or other target life for the one or more energy conversion devices (e.g., according to one or more components thereof).

The objective function can be further resolved between the various fuels, such as where F₁ corresponds to a diesel fuel blend and F₂ refers to a gas, where various blends may be used. For example, rather than increasing a substitution rate of gas, it may be advantageous to increase a proportion of biodiesel or HVO available at a refueling station. According to various embodiments, the objective function can include additional, fewer, or different variables or constraints. For example, a mining haul truck may operate with a variable payload, such that the objective function can determine a solution based upon load data 128, which may, in turn, affect fuel use, substitution rates, etc. Further, the objective function can determine a local minimum for predictive or corrective maintenance intervals, such as by buffering load from strenuous portions of a route (e.g., tunnel operation with restricted airflow, steep gradients, rough terrain, frequent start-stop conditions, or so forth).

The route planner 110 can determine a local minimum corresponding to the objective function according to a gradient descent method. That is, the route planner 110 can iteratively adjust route parameters in the direction of the steepest descent or negative gradient of the objective function until a local minimum is reached. The route planner 110 can employ genetic algorithms, simulated annealing, or particle swarm optimization to escape a sub-optimal local minimum, such as to determine another relatively advantageous local minimum. In some instances, the relatively advantageous local minimum may also be a global minimum (i.e., optimal value).

The route planner 110 can cause the energy distribution system 108 to modulate energy provided by one or more fuel sources such that a number of trips along the route or total tonnage of material is adjusted (e.g., extended). For example, a route associated with an ending fuel balance of −5 gallons upon a return to a fuel point can have a payload or speed of the vehicle 100 reduced such that the ending balance is non-negative (e.g., 0 gallons). Although such a reduction in load or speed can correspond to a reduction to a ton-mile metric during operation, the adjustment can, over an appropriate time period, increase overall productivity by reducing refueling time.

Particularly, the controller 102 can detect a current state of fill of an on-board fuel. The controller 102 can compare the current state to a pre-defined state of fill. For example, the current fill may indicate 400 liters of diesel and 50 kg of H₂, along with 50 kW of electrical energy in a battery, relative to respective reserve fuel or SoC levels. The controller 102 can include a weight of the fuel in a determination of a state of fill. For example, the controller 102 can determine a fill level based on a carbon-intensively with lower fuel loading (e.g., based on total vehicle 100 weight). The controller 102 can select a consumption rate of each energy source (e.g., a first energy source and second energy source) based on the comparison of the current state of fill to the predefined state of fill. The selection can extend a distance traveled or other vehicle operation prior to reaching the respective reserve fuel or SoC levels. For example, the controller 102 may cause the use of an energy source to reduce a fueling stop, or based on a refueling time (e.g., the use of H₂ may be increased, to extend an overall period of operation prior to refueling, or decreased based on a weighting associated with a longer refueling time than for diesel). In some instances, a time for refueling multiple fuels may be equated. For example, the amount of H₂ or diesel may be selected based on a same refueling time (e.g., where the vehicle 100 is oriented to refuel from multiple sources simultaneously).

The controller 102 can determine the extension based on a position of the vehicle, such as a GNSS position received from the route planner 110, along with a position for an energy source. The extensions may refer to an increase in a time-wise extension of operation. For example, the controller 102 can select the first consumption rate or the second consumption rate to extend the time of operation for the vehicle. The extensions can refer to a distance traveled, such as a number of discrete trips between fuel points for an on-board fuel (e.g., the extension can terminate at such a fuel point). That is, an extension of the distance can terminate at a discrete position along the route. The fuel balance is not limited to an actual quantity of fuel; a fuel reservoir or other energy storage device 106 (e.g., battery) can include a further reserve portion, or an apportioned quantity to proceed from a route to a fuel point. The controller 102 can select the first consumption rate and the second consumption rate based on a remaining fuel level of the first energy source, to extend a time of operation for the vehicle. Further, the predefined state of fill is not limited to a fixed reserve value; the controller 102 can adjust a reserve value, such as to maintain a portion of a battery SoC to regenerate a particulate filter (e.g., burn off soot) based on a predicted period of low temperature operation (e.g., descending a slope).

The route planner 110 can receive or determine a position of the vehicle 100 relative to the (predefined) route. For example, the route planner 110 can determine a position based on an elapsed time, an operator input to a user interface, a message from another portion of the vehicle control system, or a wired or wireless signal (e.g., track signaling, cellular signal, or global positioning system (GPS)). The route planner 110 can determine a speed of the vehicle 100 by a same or varying source relative to the position. The route planner 110 can update the various load predictions, emissions targets 122, or so forth during operation of the vehicle 100, or according to another period such as daily.

The route planner 110 can receive, from the energy distribution system 108, an indication of an emissions output 124 associated with a traversal of the route. For example, the indication of the emissions output 124 can vary from an expected output, such that the route planner 110 can adjust a future route plan based on the variance between an emissions target 122 output and the emissions output 124. The adjustment can be an iterative adjustment to maintain an emissions target 122 on a periodic basis. The adjustment can opportunistically harvest emission surpluses, or mitigate emission deficits. That is, responsive to an indication of an emissions output 124 exceeding the emissions target 122, the route planner 110 can define a route intended to realize a lower emissions output 124 (e.g., downwardly adjust the emissions target 122). Responsive to an indication of an emissions target 122 exceeding the emissions output 124, the route planner 110 can define a route intended to realize additional vehicle productivity (e.g., additional trips, faster trips, or larger loads), even where such additional vehicle productivity may cause the emissions output 124 to exceed the emissions target 122 for a route-segment or portion thereof. That is, the route planner 110 can determine a route plan including a consumption rate for various energy sources of a vehicle 100. An emissions output 124 corresponding to the selected fuels can exceed an emissions target 122 for one route-segments, and be less than the emissions target 122 for another route-segment.

In some embodiments, the route planner 110 can generate time-variant routes. For example, the route planner 110 can vary operations between a daytime and a nighttime (e.g., where nighttime speed restrictions may lower typical emissions, or where a renewable energy mix can change based on an absence of photovoltaic sources). Indeed, the route planner 110 can determine various consumption rates responsive various intermittent or unavailable fuels or electrical energy sources. For example, the controller 102 can receive an indication of an unavailability of an energy source, and select, based on the emissions target 122, an adjusted consumption rate for any remaining energy sources (e.g., determine a consumption rate of zero for the unavailable source, and another rate for other sources).

The vehicle 100 can include or interface with an emissions aggregator 112. The emissions aggregator 112 can be connected to various vehicles (e.g., over a wired or wireless network). The emissions aggregator 112 can generate, for a grouping of vehicles (e.g., at least two vehicles, also referred to as a fleet) an emissions target 122. Emissions targets 122 can be based on (e.g., apportioned from) a total emissions target 122. The emissions aggregator 112 can thus provide the emissions targets 122 to respective vehicles (e.g., to an energy distribution system 108 thereof) for implementation. That is, the controller 102 can be configured to interface with a second controller, the second controller communicatively connected to various vehicles including the vehicle 100. The controller 102 can receive the emissions target from the second controller. The second controller can determine, the emissions target for the vehicle, and a second emissions target for a second vehicle of the plurality of vehicles based on a total emissions target for the plurality of vehicles. The second controller can provide the emissions target to the vehicle, and the second emissions target to the second vehicle.

The emissions aggregator 112 can interface with the route planner 110 to adjust an emissions target 122 for a particular vehicle, such that an overall emissions target 122 for a site is realized. The emissions target 122 can be realized by realizing various improvements from various vehicles. For example, a 10% reduction in emissions can be realized by decreasing an emissions target 122 of a first vehicle 100 by 50% and an emissions target 122 of a second vehicle 100 by 5%. In some instances, an emissions target 122 can be realized by increasing an emissions output 124 of one or more vehicles. The emissions aggregator 112 can operate iteratively or dynamically based on feedback. For example, the emissions aggregator 112 can adjust an emissions target 122 based on an indication of emissions output 124.

The emissions aggregator 112 can realize an emissions target 122 by determining a change to a fleet of vehicles, infrastructure, or other equipment associated with a facility, site, operation, or so forth. For example an installation of an energized element such as a catenary line or third rail, a change to a fuel blend, an addition of a substitution fuel, or a replacement of a vehicle 100 (e.g., a vehicle 100 configured to operate more efficiently, burn a different fuel, operate a battery-hybrid system, or the like). The emissions aggregator 112 can employ a predefined or variable asset life, or implementation cost (e.g., an emissions output 124 associated with an infrastructure improvement).

The emissions aggregator 112 can determine a local minimum according to any of the techniques described with regard to the route planner 110. For example, the emissions aggregator 112 can determine a solution to an objective function, wherein the objective function includes variables associated with vehicles or infrastructure. For example, the objective function can include variables corresponding to additional charge capacity and weight associated with incremental battery capacity (and consequent changes to tire wear, or maintenance), reliability improvements or costs associated with equipment changes (e.g., an estimated per-period cost, such as a per hour cost), productivity improvements (e.g., reduction of queuing at fueling sites incident to additional fueling sites for various fuels), etc.

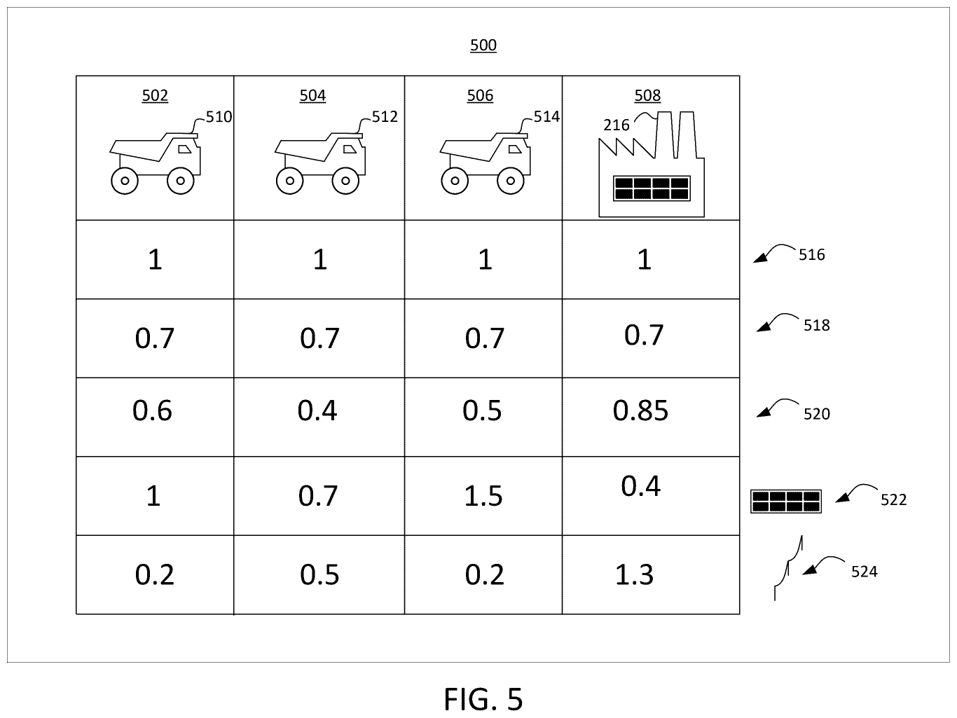

The emissions aggregator 112 can include an interface to present a selection for adjustments. The adjustments can include any of the adjustments for a single vehicle 100 (e.g., a change to a substitution rate, battery employment, or so forth). The adjustments can further include adjustments to a vehicle, facility infrastructure, or equipment. For example, a user can input information associated with an improvement (e.g., a catenary line, a fueling station, a recharging station, or an installation of photovoltaic panels) or operational change (e.g., a change in a blend of a fuel). The information can include a location along the route, an amount of energy delivered, a cost (e.g., emissions based or otherwise) associated with information, etc. The emissions aggregator 112 can generate and present an indication of an emissions output 124 associated with the adjustment. As example of such a presentation is provided at FIG. 5.

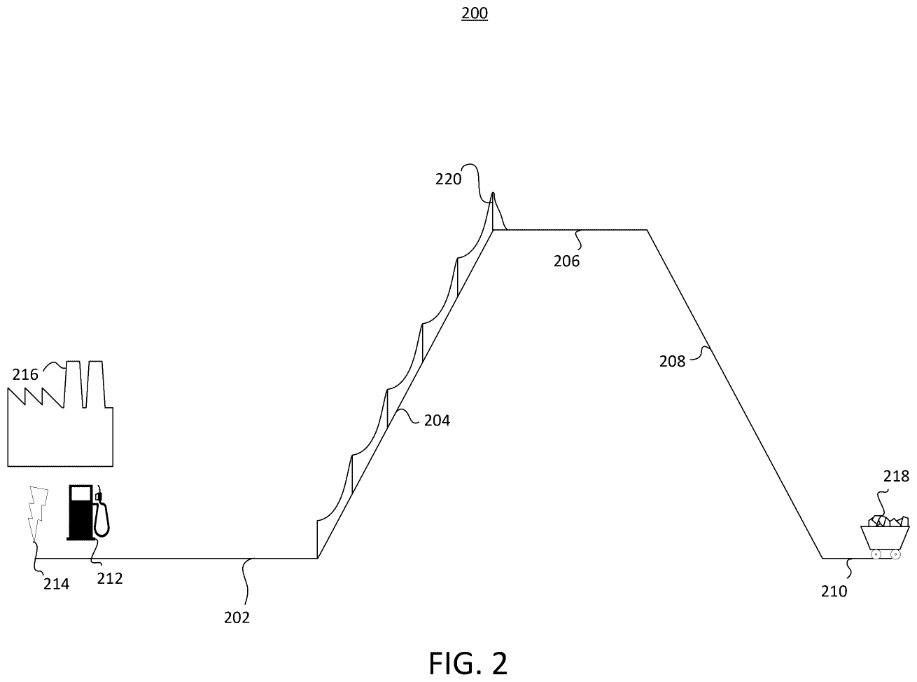

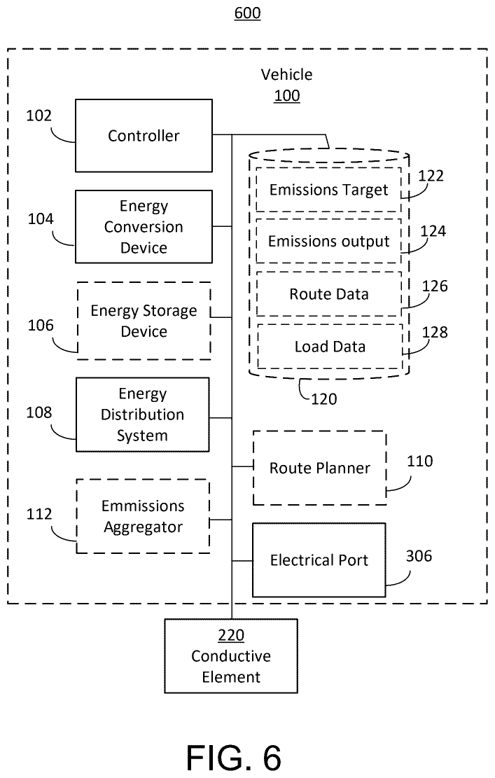

Referring now to FIG. 2, a route diagram 200 for a route is provided, according to some embodiments. The depicted route is apportioned into a first route-segment 202, a second route-segment 204, a third route-segment 206, a fourth route-segment 208, and a fifth route-segment 210. The first route-segment 202 includes a fueling station 212 and a fixed electric charging station 214. Some routes can include multiple such fueling station 212 or fixed electric charging stations 214; other routes may omit energy sources entirely, such that a vehicle 100 traversing the route may have to traverse a further route to reach an energy source. The vehicle 100 can include, for example, a vehicle 100 depicted hereinafter at FIG. 6, a vehicle including or interfacing with any of the elements of FIG. 1, or according to other aspects of the present disclosure. Further depicted along the first route is a receiving facility 216, which can refine, process, or store a material from a sourcing facility 218. Although described hereinafter as a mining facility, such a description is not intended to be limiting. For example, the receiving facility 216 can be a drop-off terminal for passengers, and the sourcing facility 218 can be an origin point for the passengers.

At the receiving facility 216, a vehicle 100 can charge a battery via the electric charging station 214, or refill one or more fuels at the fueling station 212. Any of a refuel time (corresponding to a fuel capacity), a battery charge time (corresponding to a battery SoC), or a selection of fuels (e.g., priming or substitution fuels, fuel blend selections, or so forth) can vary according to an input received from the route planner 110, based on the objective function thereof. For example, the vehicle 100 can depart from the receiving facility 216, along the first route-segment 202 with less than a full SoC of a battery. The vehicle 100 can adjust operation while traversing one route-segment based on a future route segment, or based on an instruction from the route planner 110 (e.g., a demand indication). For example, as the vehicle 100 approaches the ascent of the second route-segment 204, the vehicle 100 can increase a fuel consumption or decrease a substitution rate to charge batteries for the ascent (e.g., to maintain a desired speed during the ascent). Conversely, where the vehicle 100 is configured to receive electrical energy from a conductive element 220 such as the depicted catenary line, the vehicle 100 can deplete the battery approaching the second route-segment 204, so as to opportunistically charge during the ascent (e.g., according to emissions or cost of the energy sourced from the conductive element 220, relative to other energy sources).

In some embodiments, the fuel can consist of hydrogen (e.g., for an internal combustion engine or fuel cell). In some embodiments, the fuel can consist of HVO, wherein the relatively energy dense fuel can operate in an absence of electrical energy. For example, the fuel can be a single source fuel or blend of various sources. Energy can be sourced from the pantograph for high-load factor operation and the fuel-based system can be used on lower load portions or a route. A battery can harvest regenerative energy, buffer the fuel source for transient events or aftertreatment, etc. The controller 102 can determine how much power is generated from a fuel used to complement the pantograph.

As the vehicle 100 approaches the third route-segment 206, the route planner 110 can cause the vehicle 100 to take a further action based on a future segment of the route. For example, the vehicle 100 can stop receiving energy from the catenary line such that an amount of energy can propel the vehicle 100 along the third route-segment 206 to the fourth route-segment 208, Thereafter, the depleted battery can be charged according to regenerative braking descending the fourth route-segment 208. Such depletion can be employed, even where the energy from the catenary line is a least carbon-intensive fuel. The vehicle 100 can thus recharge the battery descending the fourth route-segment 208.

Traveling along the fifth route-segment 210, the vehicle 100 can maintain the SoC of the battery (e.g., holding the battery in reserve for a return trip for when the vehicle 100 is more heavily loaded, to increase a speed or decrease carbon-intensity). Thus, the energy distribution system 108 can provide various combinations of energy sources for the vehicle 100 during a transit from the receiving facility 216 to the sourcing facility 218. The combinations of energy sources may not satisfy the objective function for any particular segment. Indeed, the combinations of energy sources may not satisfy the objective function for the described transit. For example, a transit to the sourcing facility 218 can operate with relatively high carbon-intensity, since the emissions of the unloaded vehicle 100 may be relatively insensitive to changes in speed, and a change in speed of the vehicle 100 can substantially affect productivity. That is, the route planner 110 can determine that increasing a vehicle speed while unloaded, and slowing the vehicle 100 while loaded satisfies an emissions target 122 and increases a number of trips, ton-miles, or so forth.

The vehicle 100 can source a load at the sourcing facility 218, and generate load data 128 associated with the load. Thereafter, the vehicle 100 can navigate along the fifth route-segment 210, ascend the fourth route-segment 208 (e.g., discharging the battery to maintain a target speed), and proceed along the third route-segment 206 to the second route-segment 204. The vehicle 100 can descend the second route-segment 204 while regeneratively braking to recharge the battery. The vehicle 100 can thereafter proceed along the first route-segment 202 to the receiving facility 216. While navigating the first route-segment 202 to the receiving facility 216, the vehicle 100 can employ a battery amount based on a planned recharge time, and a return to ascend the second route-segment 204 (or proceed to another route).

Referring now to FIG. 3, an energy flow diagram 300 for a vehicle 100 is provided according to some embodiments. The vehicle 100 can include any number of reservoirs corresponding to various fuels and blends thereof. For example, the depicted embodiment includes a diesel reservoir 302 configured to receive a variable blend of any combination of petroleum diesel 302A, HVO 302B, or Biodiesel 302C. The variable blend can include B0 (e.g., can be petroleum diesel 302A) or B100. The controller 102 can select between various mixable fuels or blends thereof. The blend may be selected according to a selected engine assembly, local availability, or an indication, from the route planner 110, of a blend to optimize an objective function. For example, the controller 102 can select, based on an emissions target 122, a fuel blend ratio between mixable fuels having different carbon-intensities, such that one has a greater carbon intensity than the other. The depicted embodiment includes a CNG or LNG reservoir 304, which can receive CNG/LNG from various sources, such as green sources 304A (e.g., from renewable biomass), blue sources 304B (e.g., from processes employing carbon capture), gray sources 304C (e.g., fossil fuel sources), or variable blends thereof that may be selected according to similar criteria as discussed above with regard to the diesel reservoir 302. The controller 102 can receive an indication of such sources and select a consumption rate of one or more energy sources based on a sourcing thereof (e.g., may select a consumption rate of the diesel reservoir 302 based on a source of fuel disposed therein).

The engine 308 receives energy from one or more fuel sources (e.g., the diesel reservoir 302 and the CNG/LNG reservoir 304). The engine 308 can alternate or substitute a portion of the fuel received according to an indication from the energy distribution system 108. For example, the engine 308 can receive a greater portion of diesel based on the load data 128, such as a gross vehicle weight of a combination of the vehicle 100 and a payload, (e.g., relatively heavy iron ore) or a greater portion of CNG/LNG when unloaded, or carrying a lesser payload (e.g., relatively light overburden). Energy from the engine 308 can be conveyed to a mechanical propulsion component, or, as depicted, to an alternator 310 which can, in turn route the power to a battery 312 or an electric motor such as the depicted traction motor 314.

Further depicted is an electrical port 306. The electrical port 306 can be or include portions configured to receive energy at a halt, or while traversing the route. The electrical port 306 can be configured to interface with one or more electrical sources. For example, the electrical port 306 can include a pantograph configured to receive energy from a catenary line, a pickup shoe configured to receive energy from an electrified rail, or a receptacle configured to receive energy from a charging point. That is, the controller can cause an energy storage device 106 such as a battery 312, to receive electrical energy via the electrical port 306 (e.g., at the pantograph) while traversing one or more route-segments. The electrical port 306 can supply energy to the traction motor 314 or the battery 312. That is, the vehicle 100 can include various relays, switches, inverters, or so forth, along with pumps, valves, filter elements, corresponding to the diesel reservoir 302.

During operation, energy received from the engine 308, electrical port 306, or battery 312 are modulated according to an instruction received from an energy distribution system 108. The energy can be used to propel the vehicle 100, prepare to propel the vehicle 100 in the future, harvest energy (e.g., depleting the battery 312 prior to descending a grade), or another energy or emissions management operation (e.g., the engine 308 may be loaded to aid in regenerating a particulate filter). The modulation can include an adjustment of fuels consumed by the engine, a net charge or discharge of the battery 312 (e.g., from the electrical port 306, the alternator 310, or the traction motor 314 via regenerative braking). In some instances, the engine 308 can shutoff when a load is less than a threshold, such as where another energy source (e.g., gravity, the battery 312, or a third rail connected to the electrical port 306) can propel the vehicle 100.

The depicted energy flow diagram 300 is not intended to be limiting. Vehicles 100 can include various cab electronics, capacitor banks, flywheels, blowers, or so forth. For example, a vehicle 100 can include a battery-driven blower configured to cool some engine components, so as to increase a maximum engine output to the alternator 310 (e.g., by shifting the blower load from the engine to the battery 312).

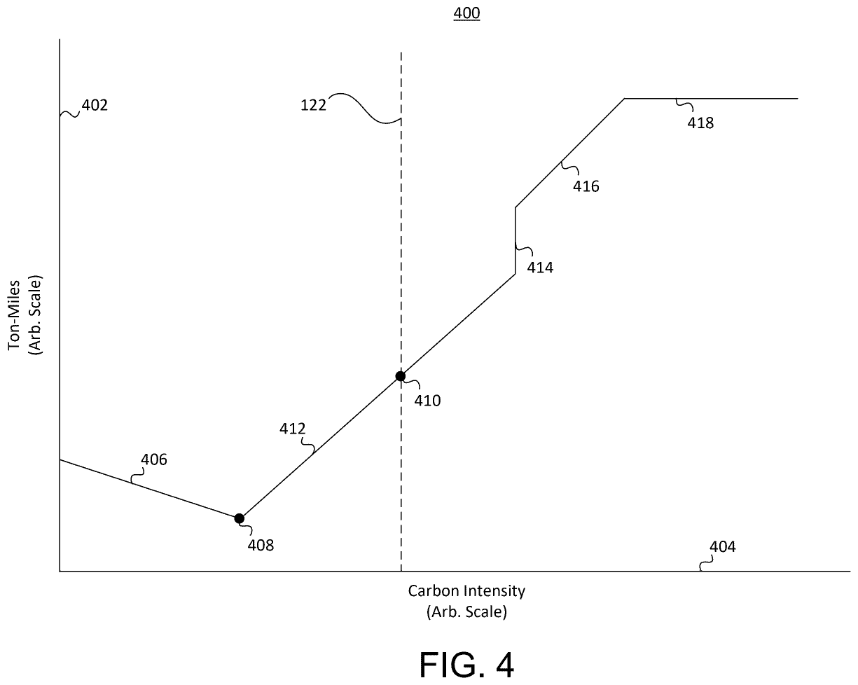

Referring now to FIG. 4, an intensity-production diagram 400 for a vehicle 100 is provided, according to some embodiments. The intensity-production diagram 400 can include any number of axes, such as a productivity axis 402 (e.g., depicted as a ton-miles axis), and a carbon-intensity axis 404, which can depict an indication of a carbon-intensity according to various emissions outputs 124 (e.g., well-to-wheel, tank-to-wheel, etc.). Both axes are depicted according to an arbitrary scale which will, in any case, vary according to various implementations of the present disclosure. As depicted, the carbon-intensity can correlate generally positively with productivity, corresponding to reduced vehicle speeds when substituting low-carbon fuels, increased dwell times for battery recharging, and so forth. In some instances, or for some portions of intensity-production diagrams 400 for vehicles 100 or other equipment, such a correlation may be positive. For example, increasing a vehicle speed from relatively low speeds (less than an efficiency band of an internal combustion engine) can increase productivity and lower carbon-intensity, as shown by a first portion 406 of the intensity-production diagram 400 (e.g., a transport vehicle 100 idling at a halt has an efficiency of zero).

A local minimum 408, which also corresponds to an absolute minimum of the depicted curve depicts a point of maximum efficiency for the vehicle 100. Because the emissions output 124 associated with the local minimum 408 is less than the emissions target 122, the system can realize greater productivity within the emissions target 122. That is, a local minimum which satisfies an objective function of the route planner 110 may not be a local minimum for efficiency alone. For example, the vehicle 100 can operate at an operating point 410 along a second portion 412 of the curve, which may be at or closer to a power band of operation of the internal combustion engine, relative to the local minimum 408. Further portions of the curve include a third, vertical portion 414 associated with a change in productivity that does not correspond to a change in carbon-intensity (e.g., corresponding to an increase in vehicle speed which increases a dwell time at a charging station 214 for a PHEV). A fourth portion 416 of the curve exhibits positive productivity-intensity correlation. A fifth portion 418 of the curve exhibits no further productivity increase corresponding to an increase in intensity. This portion may correspond to a productivity which is gated by another portion of a site (e.g., operating on 0% substitution fuel to reach a maximum vehicle speed to reach a location where the vehicle 100 will dwell may not increase productivity, but may increase emissions).

Although not depicted, for clarity, the intensity-production diagram 400 can include various other axes. For example, another axis can depict a cost related to the fuel, vehicle depreciation, labor costs, or so forth. A further axis can depict a renewable content of a source of electrical energy. A further axis still can depict a fuel blend utilized (e.g., a percent biodiesel 302C of a fuel for the diesel reservoir). Thus, the operating point 410 can shift leftward or rightward along the depicted curve based on various functions of the various axes. The route planner 110 can adjust (or provide an indication for an adjustment) of at least a portion of the various axes. For example, the route planner 110 can determine that a non-fossil based pilot fuel blend can be modulated (e.g., between HVO 302B and petroleum diesel 302A), that a substitution rate of another fuel (e.g., LNG/CNG) can be increased, or that an increased proportion of energy expended by the vehicle 100 can be sourced from electrical energy (e.g., from a stationary charging point, or conductive element 220 extending along a route such as a catenary line, increased regenerative braking, etc.).

Moreover, the route planner 110 can operate according to a time-variant objective function, to alternatively over-run and under-run an emissions target 122 according to a season, time of day, day of week, or other period, wherein the emissions target 122 is for a period extending at least as long as the period (e.g., per quarter, per annum, etc.). Thus, the route planner 110 can generate an output describing various operational changes (e.g., adjustments to speed or fuel blends) or capital functions (e.g., deployment of chargers or photovoltaic panels). That is, a local minimum of the objective function (different from the local minimum 408 corresponding to carbon-intensity) can include an adjustment to any of the axes of an intensity-production diagram 400.

FIG. 5 is a user interface 500 depicting various vehicles of a facility, according to some embodiments. The user interface 500 provides columns corresponding to various emissions. For example, the various columns can correspond to a same vehicle 100 (or arbitrary set of like vehicles) navigating various routes, or to a route navigated by a set of vehicles 100. For simplicity and brevity, hereinafter, reference will be made to a first column 502 corresponding to a first haul truck 510 or other vehicle 100 navigating a first route, a second column 504 corresponding to a second haul truck 512 or other vehicle 100 navigating a second route, and a third column 506 corresponding to a third haul truck 514 or other vehicle 100 navigating a third route. A fourth column 508 corresponds to other equipment, particularly, to a receiving facility 216.

A first row 516 indicates a baseline emissions level corresponding to the respective vehicles and equipment (e.g., normalized to 1). As second row 518 indicates a proportional apportioned reduction of 30% in emissions applied to the various vehicles 510, 512, 514 and equipment. Although such an apportionment may satisfy an emissions target 122, the apportionment may not correspond to a local minimum of a productivity-related objective function. That is, another apportionment having a same emissions output 124 may realize greater production (or correspond to improvements to other axes of a hyperplane solution space of an objective model, such as reliability, expense, or so forth). A third row 520 indicates an apportionment, by the emissions aggregator 112, of emissions according to a local minimum of an objective function. For example, a less intensive but less productive operation of the haul trucks 510, 512, 514 and a relatively intensive (relative to the trucks) operation of the receiving facility 216 can satisfy the objective model (e.g., correspond to a local minimum). For example, in some instances, such a row can correspond to an optimal solution of a global minimum.

A fourth row 522 provides a photovoltaic panel which, as depicted, can be employed to provide energy to the receiving facility 216, lowering an intensity of the operation thereof. The emissions aggregator 112 can determine an emissions budget can be shifted from the receiving facility 216 to the haul trucks 510, 512, 514, such that the haul trucks 510, 512, 514 can operate relatively intensively. A fifth row 524 provides a conductive element 220 which can substantially reduce an intensity of operation of the haul trucks 510, 512, 514, and may further, increase productivity relative to baseline (e.g., because the conductive element 220 may increase maximum speeds up slopes, relative to a diesel engine). The emissions aggregator 112 can determine an emissions budget can be shifted from the haul trucks 510, 512, 514 to the receiving facility 216. Further columns can correspond to further potential changes, such as changes to vehicle types, changes to fuels or blends thereof, or so forth. Further, the apportionment can correspond to local minimums determined according to various factors, such as any factor described herein (e.g., reliability, expense, availability, storage, bulk, weight, etc.).

FIG. 6 is a block diagram of a system 600 including an engine configured to operate based on various fuels, according to some embodiments. The system 600 to generate mechanical energy for propulsion of a vehicle 100 includes an electrical port 306 configured to receive electrical energy from a conductive element 220 exterior to the vehicle 100, the conductive element 220 disposed along a route for the vehicle 100. The system 600 includes an energy conversion device 104 configured to receive a first fuel and a second fuel. The system 600 includes a controller 102 configured to determine, based on an energy demand, a first consumption rate of the first fuel, and second consumption rate of the second fuel.

Various operations depicted herein may be referred to briefly, merely for brevity of this disclosure. With particular reference to, for example, FIG. 1, with reference to any of the controller 102, energy conversion device 104, or energy distribution systems 108. In some embodiments, any of the present embodiments can be modified according to the various references to the energy storage device 106, route planner 110, or emissions aggregator 112, along with any of the data structures of the data repository. Further, indication of the depicted electrical port 306 and conductive element may be modified or understood according to the disclosures of, for example, FIGS. 2, 3, and 7.

In some embodiments, the determination of the first consumption rate and the second consumption rate is based on an emissions target 122. The determination can be based on a first emissions output 124 for the first fuel. The determination can be based on a second emissions output 124 for the second fuel. The determination can be based on a third emissions output 124 for the electrical energy. Such elements can be modified according to, for example, various references to objective function herein and according to any other portion of the present disclosure.

In some embodiments, the controller 102 is configured to determine the first consumption rate of the first fuel and the second consumption rate of the second fuel. The determination can be based on a quantity of electrical energy received from the conductive element 220. Such elements can be modified according to, for example, various references of FIG. 1 and according to any other portion of the present disclosure.

In some embodiments, the controller 102 is configured to determine the first consumption rate of the first fuel and the second consumption rate of the second fuel. The determination can be based on a source of the electrical energy received from the conductive element 220. Such elements can be modified according to, for example, various references to fuel sourcing at FIG. 3 and according to any other portion of the present disclosure.

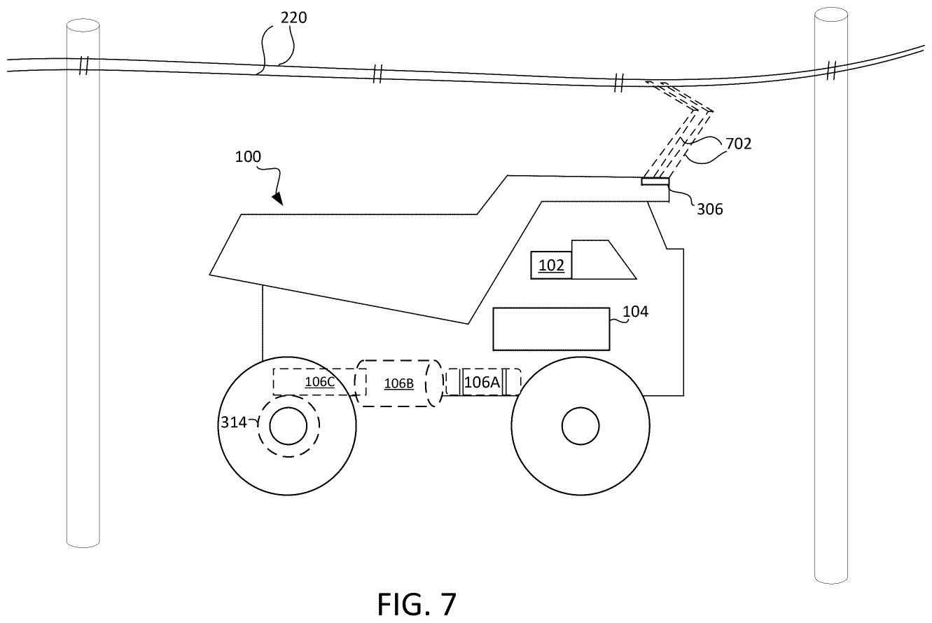

In some embodiments, the controller 102 is configured to receive the route, the route including a plurality of route-segments. The controller 102 can be configured to cause the vehicle to receive, from the electrical port 306, a quantity of electrical energy along a first route-segment. The quantity of electrical energy can be based on a second route-segment of the plurality of route-segments. Such elements can be modified according to, for example, various references to routes and route segments herein, such as FIGS. 2 and 7, as indicated above, according to any other portion of the present disclosure.

In some embodiments, the controller 102 is configured to determine the quantity of electrical energy based on a speed of the vehicle 100 navigating the first route-segment, the speed based on the second route-segment of the route. Such elements can be modified according to, for example, various references to objective function herein and according to FIG. 1, 2, 4, 5, 7, or any other portion of the present disclosure.

In some embodiments, the quantity of electrical energy is based on a portion of the quantity of electrical energy provided to an energy storage device. The energy storage device can be configured to provide electrical energy to a traction motor during the second route-segment of the route. Such elements can be modified according to, for example, various references to conductive elements with regard to depicted throughout the present disclosure.

In some embodiments, the vehicle includes a traction motor 314 to generate electrical energy via regenerative braking while descending a grade of the second route-segment. The controller can determine the quantity of electrical energy based on the regenerative braking for the grade. Such elements can be modified according to, for example, various references to conductive elements with regard to depicted throughout the present disclosure.

In some embodiments, the energy conversion device 104 is configured to generate electrical energy from a fuel source. The controller 102 can be configured to receive an indication of an emissions target 122. The controller 102 can be configured to receive an indication of an emissions output 124 corresponding to the fuel source and a quantity of electrical energy. The controller 102 can be configured to determine, based on the emissions target and the emissions output, the quantity of electrical energy. Such elements can be modified according to, for example, various references to conductive elements with regard to depicted throughout the present disclosure.

FIG. 7 is a depiction of a vehicle 100 traversing a route, according to some embodiments. The vehicle 100 includes an electrical port 306 configured to receive electrical energy from a conductive element 220 disposed along a route for the vehicle 100. For example, the conductive element is depicted as a catenary line. According to various embodiments, the conductive element 220 can be implemented in various ways, such as the depicted catenary line to interface with a pantograph 702, a third rail to interface with a pickup shoe, or other stationary element configured to supply electrical energy to a moving vehicle 100. The pantograph 702 includes a spring element, pneumatic system, or other elastic member configured to maintain contact with the catenary line. A controller 102 associated with the vehicle can control a quantity of electrical energy received from the conductive element 220, such as by adjusting a rate of energy received, or a time period receipt of the electrical energy.

The vehicle 100 includes an energy conversion device 104 configured to receive one or more fuels (e.g., at least a first). The vehicle 100 includes a controller 102. The controller 102 determines a first consumption rate of the first fuel based on an energy demand for the energy conversion device.

The respective fuels may each be associated with various carbon-intensities, power generation potential, costs, or so forth. At least a portion of the controller 102 is depicted as local to the vehicle 100 (e.g., constituent to a control system thereof). In various embodiments, the controller 102 can include one or more processors which are local to the vehicle 100, remote from the vehicle 100, or a combination of processors which are local to and remote from the vehicle 100. The controller 102 can determine a consumption rate for each of the various fuels. The controller 102 can determine the respective consumption rates based on an emissions output 124, cost, power generation potential, or other attribute of the various fuels.

For example, the controller 102 can determine a first consumption rate of the first fuel based on a second consumption rate of a second fuel for the energy conversion device. The controller 102 can determine the first consumption rate and the second consumption rate based on an emissions target for the vehicle.

In some embodiments, the controller 102 is configured to execute an objective function to determine the first consumption rate and the second consumption rate. The objective function may be based on (e.g., include as parameters) the emissions target 122, a first emissions output 124 for the first fuel, a second emissions output 124 for the second fuel, and an operating parameter that correlates positively with a total emissions output 124 for the vehicle 100. The objective function can further be based on an operating parameter of the vehicle 100, the operating parameter correlating positively with a total emissions output 124 for the vehicle 100. For example, the operating parameter can include intensity of operation, battery health or other equipment lifing or maintenance.

The controller 102 can further determine an emissions output 124 for one or more fuels or other energy sources. For example, the controller 102 can determine a first emissions output for the first fuel. The controller 102 can determine a first emissions output for the second fuel. The controller 102 can determine a third emissions output 124 for the electrical energy, wherein a sum of the first emissions output 124, the second emissions output 124, and the third emissions output 124 does not exceed the emissions target 122.

Power generation potential can refer to an amount of power generated by a fuel. For example, some diesel or diesel-adjacent fuels have greater power generation potential than some substitution fuels such as CNG or LNG.

Referring again to the various fuels, the vehicle 100 can include an energy storage device 106 configured to receive one or more fuels. For example, a first energy storage device can be configured to receive a first blend of a fuel associated with a first emissions output 124, such as a blend of petroleum diesel, bio-diesel, HVO, or various other diesel-adjacent fuels (e.g., can be a diesel reservoir 302). A second energy storage device 106B can be configured to receive another fuel, such as a fuel configured to be selectively substituted according to control signals generated by the controller 102, for a fuel of the first energy storage device 106A. For example, the second energy storage device 106B can receive natural gas, hydrogen, or another fuel. That is, the second energy storage device 106B can be or include a CNG/LNG reservoir 304, as is depicted in FIG. 3. References to the various fuels can include a selection between fuel reservoirs, or a selection for one or more reservoirs. For example, selection of a consumption rate of petroleum diesel can be modulated according to an increased proportion of natural gas, or by sourcing a diesel blend including biodiesel. A third energy storage device 106C can store electrical energy, such as in the case of a battery 312. The electrical energy can be sourced from the electrical port 306 (e.g., via the pantograph 702), the energy conversion device 104, or another source, such as regenerative braking.

The controller 102 can determine a consumption rate for the one or more fuels based on emissions outputs 124 associated with the fuels, as well as an emissions output 124 associated with the electrical energy (e.g., along with various other attributes). For example, the controller 102 can receive an emissions output 124 associated with electrical energy, such as a carbon intensity of grid-derived energy, photovoltaic panels, generators, or so forth. For example, the controller 102 can compare a power demand to an available supply of energy from the conductive element 220. In some instances, the controller 102 can determine the consumption rate of the fuels based on a quantity of electrical energy available from the conductive element 220. For example, in an illustrative example, the controller 102 can preferentially select the electrical energy from the conductive element 220 based on an emissions output 124, cost, or other attribute of the electrical energy. The controller 102 can compare a total power demanded to an available quantity of electrical energy from the conductive element 220, and operate another energy conversion device 104 (e.g., engine assembly) to generate a remaining portion of energy. The controller 102 can adjust the consumption rate of the fuels, such as by generating control signals to actuate pumps, valves, injectors, or communication with further controllers.

In some embodiments, the controller 102 can determine the consumption rates of the various fuels based on an emissions target 122. For example, the controller 102 can receive an emissions target 122, and determine a combination of energy sources which does not exceed the emissions targets 122 to operate the vehicle. The combination of energy sources can include an emissions output 124 associated with the electrical energy derived from the conductive element, along with further emissions outputs 124 for the various fuels of the vehicle 100. The determination can be according to the objective functions described with regard to FIG. 1. Indeed, the depicted vehicle 100 can include or interface with any of the components of FIG. 1, which may be instantiated locally at the vehicle 100, or remote therefrom, according to various embodiments.

In some embodiments, the controller 102 is configured to determine the fuel consumption rates of the various fuels based on time variant vehicle operation. For example, the controller 102 can be configured to generate control signals to cause the vehicle 100 to store electrical energy (e.g., in a battery 312), or convert electrical energy to another energy source for storage (e.g., as hydrogen gas or thermal energy of a methane cracker) which is thereafter employed for vehicle propulsion. Hereinafter, some references will be made to a hybrid locomotive including a battery 312, merely for brevity; any such examples can substitute the battery 312 for other energy storage devices.

The time variant behavior of the vehicle 100 can include charging or discharging a battery 312. The vehicle 100 can charge the battery 312 from various sources, such as from a fuel-consuming energy conversion device 104, the conductive element 220, a fixed charging station 214, or regenerative energy from electrical motors of the vehicle 100. Moreover, the controller 102 can operate based on a predefined route, predicted route, or other forward looking route data 126. Thus, the controller can generate control signal to cause the vehicle to charge or discharge the battery during one portion of a route based on another (future) route portion.

The controller 102 can cause a charging of the battery 312 based on a future route portion wherein an amount of energy demand exceeds an amount of power available from a conductive clement 220. Such an instance may arise in an absence of a conductive element 220 disposed along a portion of a route. For example, as a vehicle 100 reaches a terminus of the conductive element 220, the controller 102 can charge the batteries 312 to maintain electrical sourced energy while traversing a further portion of a route. The charging can be based on a low emissions output 124 for a source of the electrical energy received from the conductive element 220, relative to another energy source. Charging of the battery 312 may refer to fully charging a battery, or otherwise increasing a battery SoC.

The controller 102 can discharge the battery 312 based on a future route-segment. For example, the discharge can precede an interface of the pantograph 702 with the catenary line, to reduce fuel use, increase a substitution rate, or otherwise correspond to the determination of the consumption rates of the various fuels. In another example, a route can include a halt proximal to a fixed charging station 214, or a portion associated with regenerative braking such that a high battery SoC may be undesirable. An associated employment of a frictional braking system, or an emissions output 124, financial cost, or other cost of an objective function associated with the conductive element-sourced electrical energy may cause the controller 102 to discharge (e.g., deplete), or not charge the battery. The electrical energy available (or actually derived) from the conductive element 220 may be one of various energy sources evaluated according to various objective functions. The vehicle 100 can include an electric generator (e.g., a traction motor to generate electrical energy via regenerative braking while descending a grade of a route-segment). A quantity of electrical energy received during a different route-segment can be based on the grade. For example, the battery can be depleted navigating a route segment prior to a downward grade, or charged navigating a route segment prior to an upward grade, as depicted in FIG. 2.

The controller 102 can control the charging based on battery health parameters, such as a time at a state of charge exceeding a threshold, a charge rate, or thermal load applied to a battery. For example, by charging proximal to the terminus of the conductive element, a period of time that the battery 312 is at a full state of charge can be reduced which may aid in battery aging. Conversely, initiating battery charging earlier may decrease a charge rate, which may lower a thermal load on the battery, which may aid in battery aging. Similarly, the controller 102 can deplete the battery 312 according to a battery health parameter, such as a SoC above an SoC threshold, or reduce an excursion time during which the battery SoC is below the SoC threshold. For example, the objective function can incorporate various battery health parameters such as temperature, charge/discharge cycles, time at high or low SoC, or so forth.

The controller 102 can control the quantity of electrical energy received from the conductive clement 220 according to a vehicle speed, wherein the speed is based on another portion of the route. For example, the vehicle 100 can navigate one portion of a route at a slower rate, to increase a quantity of energy provided to the battery, such that, during another portion of the route, the stored energy can be employed to increase a vehicle speed. The reduced speed (while receiving energy from the conductive element 220), in combination with the increased speed along the other route portion can reduce a total time to navigate the route, or otherwise incur a benefit according to an objective model (e.g., the stored energy can reduce an emissions output 124 associated with the subsequent increased speed).

The quantity of electrical energy received from the conductive element 220 can be associated with a present speed of the vehicle, or, as described above, based on a portion of the quantity of energy received from provision to the energy storage device 106. The stored energy can be used to propel the vehicle, or perform various auxiliary functions thereof. For example, charging a battery which is thereafter used for various functions other than vehicle propulsion can affect an emissions output, such as by reducing a load for an engine assembly, which may, in turn, increase vehicle speed, increase a fuel substitution rate, aid in engine assembly start-stop operation, or so forth.

FIG. 8 is a block diagram illustrating an architecture for a computer system 800 that can be employed to implement elements of the systems and methods described and illustrated herein. The computer system or computing device 800 can include or be used to implement a controller 102 or its components, and components of the vehicle. The computing system 800 includes at least one bus 805 or other communication component for communicating information and at least one processor 810 or processing circuit coupled to the bus 805 for processing information. The computing system 800 can also include one or more processors 810 or processing circuits coupled to the bus for processing information. The computing system 800 also includes at least one main memory 815, such as a random-access memory (RAM) or other dynamic storage device, coupled to the bus 805 for storing information, and instructions to be executed by the processor 810. The main memory 815 can be used for storing information during execution of instructions by the processor 810. The computing system 800 can further include at least one read only memory (ROM) 820 or other static storage device coupled to the bus 805 for storing static information and instructions for the processor 810. A storage device 825, such as a solid-state device, magnetic disk, or optical disk, can be coupled to the bus 805 to persistently store information and instructions (e.g., for the data repository 120).

The computing system 800 can be coupled via the bus 805 to a display 835, such as a liquid crystal display, or active-matrix display. An input device 830, such as a keyboard or mouse can be coupled to the bus 805 for communicating information and commands to the processor 810. The input device 830 can include a touch screen display 835.

The processes, systems and methods described herein can be implemented by the computing system 800 in response to the processor 810 executing an arrangement of instructions contained in main memory 815. Such instructions can be read into main memory 815 from another computer-readable medium, such as the storage device 825. Execution of the arrangement of instructions contained in main memory 815 causes the computing system 800 to perform the illustrative processes described herein. One or more processors in a multi-processing arrangement can also be employed to execute the instructions contained in main memory 815. Hard-wired circuitry can be used in place of or in combination with software instructions together with the systems and methods described herein. Systems and methods described herein are not limited to any specific combination of hardware circuitry and software.

Although an example computing system has been described in FIG. 8, the subject matter including the operations described in this specification can be implemented in other types of digital electronic circuitry, or in computer software, firmware, or hardware, including the structures disclosed in this specification and their structural equivalents, or in combinations of one or more of them.

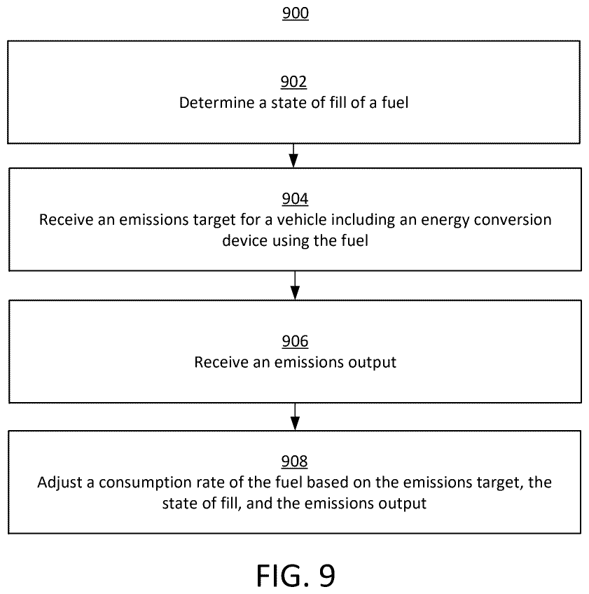

FIG. 9 is a flow chart illustrating a method 900 for vehicle energy source selection, according to some embodiments. A current state of fill of a fuel is determined at operation 902. An indication of an emissions target for a vehicle 100 is received at operation 904. The vehicle 100 includes one or more energy conversion devices 104 configured to generate mechanical movement from various energy sources comprising the fuel. An indication of an emissions output 124 for each of the various energy sources is received at operation 906. A consumption rate of the fuel is adjusted at operation 908, based on the emissions target 122, the current state of fill, and the emissions output 124 for each of the various energy sources.

In some embodiments, the consumption rate of the fuel is adjusted based on a target life for the one or more energy conversion devices 104. For example, the consumption rate may be adjusted downward during high engine load or during a low RPM/high-torque condition to extend the life of a crankshaft, or during sustained operations to reduce heat accumulated in an engine.

In some embodiments, further consumption rates can be determined for further energy sources. For example, a second consumption rate can be adjusted for a second fuel of the various energy sources, as may also be based on the emissions target 122. The second consumption rate can be adjusted based on a state of fill of the second fuel, and a second emissions output for the second fuel. In some embodiments, one of the first fuel or the second fuel can be a hydrocarbon fuel and the other of the first fuel or the second fuel can be a substitute fuel for the hydrocarbon fuel (e.g., ammonia, hydrogen, or natural gas). In some embodiments, the method includes determining a third consumption rate of electrical energy of a battery based on a state of charge (SoC) of the battery. For example, the third consumption rate of electrical energy can correspond to a positive or negative rate (e.g., charging or discharging the battery).

The adjustment to any of the consumption rates can depend on other consumption rates. For example, the adjustment to the consumption rate of the fuel can be based on the second consumption rate and the third consumption rate. The determinations of any of the consumption rate, the second consumption rate, or the third consumption rate (e.g., the consumption rate of the fuel, the second consumption rate of the second fuel, and the third consumption rate of the electrical energy) can be determined according to a local minimum of an objective function.

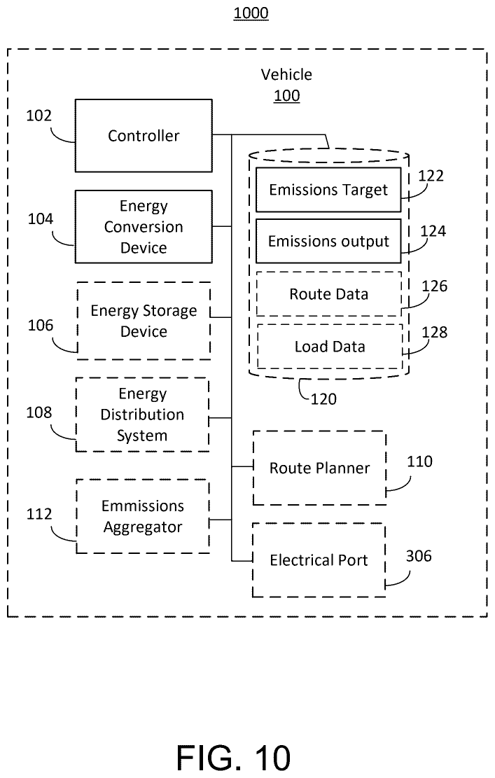

FIG. 10 is a block diagram of a controller 102 for vehicle energy source selection, interfacing with various further components of an environment. The controller 102 can include one or more processors coupled with memory. For example, the one or more processors can be disposed locally or remote from one another. The controller 102 is couplable with an energy storage device of a vehicle 100, the energy conversion device 104 configured to generate mechanical movement from a plurality of fuels. The controller 102 is configured to receive an indication of an emissions target 122 for the vehicle 100. The controller 102 is configured to receive an indication of a first emissions output 124 corresponding to a first fuel of the plurality of fuels and a second emissions output corresponding to a second fuel of the plurality of fuels. The controller 102 is configured to execute an objective function to select a first consumption rate for the first fuel and a second consumption rate for the second fuel. More particularly, the controller 102 selects the first and second consumption rates based on the emissions target, the first emissions output, the second emissions output.

The controller further selects the first and second consumption rates based on an operating parameter of the vehicle, the operating parameter correlating negatively with a third emissions output for the vehicle. For example, the operating parameter can relate to a fuel cost, equipment life parameter, vehicle speed, load carried, number of trips completed, or so forth.

In some embodiments, the controller 102 is a controller 102 of a system. The system can include any of the components disclosed herein. For example, the system can include the one or more energy conversion devices 104 operatively coupled with the controller 102. The system can include one or more energy storage devices 106 operatively coupled with the controller 102.

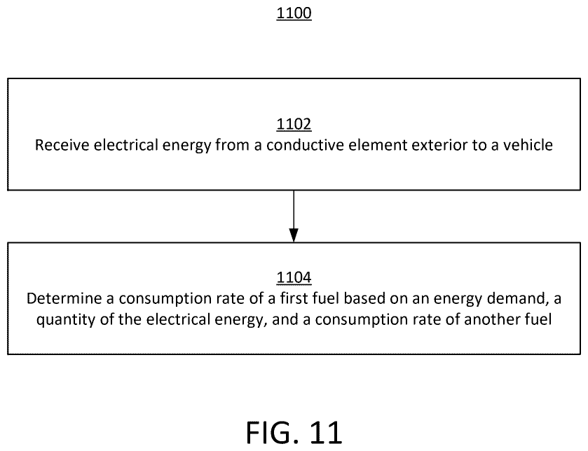

FIG. 11 is a flow chart illustrating a method 1100 for vehicle propulsion. At operation 1102, electrical energy is received from a conductive element 220 exterior to a vehicle 100 at an electrical port 306 of the vehicle 100 while traversing a route based on control signals generated by a controller 102. The controller 102 determines a first consumption rate of a first fuel at operation 1104. The determination is based on an energy demand for an energy conversion device 104 of the vehicle 100, the energy conversion device 104 configured to receive the first fuel and a second fuel. The determination is based on a quantity of the electrical energy. The determination is based on a second consumption rate of the second fuel.

In some embodiments, the controller 102 determines the first consumption rate based on an emissions target 122, a first emissions output 124 for the first fuel, and a second emissions output 124 for the second fuel. For example, the controller 102 can determine the consumption rates by determining multiple emissions outputs 124 (e.g., at least the first and second emissions outputs 124). In some cases, such a consumption rate may not correspond to a minimum emissions output 124. For example, the controller 102 can determine a total emissions output 124 (e.g., a sum of at least the first and second emissions output 124) which is less than the emissions target 122. The amount can be determined to modulate non-emissions aspects, such as speed to travel, time between refueling, or so forth.

In some embodiments, the method 1100 includes determining, by the controller 102, a source of the electrical energy. For example, the method 1100 can determine that electrical energy is sourced from photovoltaic panels, coal or other carbon-based source, or via regenerative braking, local to a vehicle. The determination of the source can include determining a combination source, such as an energy grid receiving each of renewable and non-renewable source sources. The controller can determine an emissions output associated with the electrical energy based on the source. For example, the controller can determine the output based on data received from an operator of a gird, or other data sources. The controller 102 can determine the first consumption rate based on the emissions output 124.

In some embodiments, the controller 102 can receive various route-segments of the route. The controller 102 can adjust, while the vehicle traverses a first route-segment of route-segments, the quantity of the electrical energy based on a predicted load demand of the vehicle during traversal of a second route-segment of the route-segments. For example, when approaching a catenary line, uphill, or downhill portion of the route, the controller 102 can adjust an amount of energy received (e.g., to avoid charging batteries prior to downhill portions where regenerative braking may be used).

Further, the controller 102 can allocate first and second portions of the emissions target 122 to a first and second route-segment. The controller 102 can determine the quantity of the electrical energy to satisfy the emissions target based on the multiple segments. For example, the controller can cause the emissions output 124 to exhibit time-variance (e.g., greater emissions for an uphill portion and lower emissions for a downhill portion). Accordingly, the first portion of the emissions target may not satisfy the emissions target, the second portion of the emissions target may satisfy the emissions target, and a combination of the first portion and the second portion can satisfy the emissions target 122. In some embodiments, the controller can determine or adjust a speed for the vehicle based on the quantity of electrical energy. For example, the controller 102 can increase a speed when electrical energy is available to propel the vehicle, or decrease a speed where no electrical energy is available (or where available electrical energy is less than a load demand, a battery recharging, or so forth). The quantity of electrical energy itself can depend on the speed. For example, higher speed traversals of route segments including conductive elements 220 can lower a total quantity of electrical energy received therefrom. The controller 102 can determine the quantity of electrical energy based on a speed of the vehicle.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining can be stationary (e.g., permanent or fixed) or moveable (e.g., removable or releasable). Such joining can be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling can be mechanical, electrical, or fluidic. For example, circuit A communicably “coupled” to circuit B can signify that the circuit A communicates directly with circuit B (i.e., no intermediary) or communicates indirectly with circuit B (e.g., through one or more intermediaries).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 100 as shown in the various exemplary embodiments is illustrative only. For example, some component of or for (e.g., interfacing with) the vehicle 100 can be positioned remote from the vehicle 100. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A controller for energy source selection configured to:
receive an indication of an emissions target for a vehicle, the vehicle comprising one or more energy conversion devices configured to generate mechanical movement from a first energy source and a second energy source;
receive an indication of a first emissions output corresponding to the first energy source and a second emissions output corresponding to the second energy source; and
select, based on the emissions target, the first emissions output, and the second emissions output, a first consumption rate for the first energy source and a second consumption rate for the second energy source.

2. The controller of claim 1, further configured to:
determine the first consumption rate for the first energy source, wherein the first energy source comprises a first fuel and a second fuel; and
determine the second consumption rate for the second energy source, wherein the second energy source comprises a source for electrical energy, wherein a first energy conversion device of the one or more energy conversion devices:
is configured to generate the mechanical movement from the first fuel and the second fuel; and
is not configured to generate the mechanical movement from the electrical energy.

3. The controller of claim 2, further configured to generate control signals configured to:
cause the first energy conversion device to receive the first fuel at the first consumption rate; and
cause the first energy conversion device to receive the second fuel at the second consumption rate.

4. The controller of claim 1, wherein:
the vehicle comprises an alternator including a rotor, wherein the mechanical movement comprises a movement the rotor, the alternator configured to provide electrical energy to propel the vehicle; and
the controller is further configured to control a transfer of energy from an internal combustion engine of the one or more energy conversion devices to the alternator according to a quantity of fuel provided to the internal combustion engine.

5. The controller of claim 1, further configured to:
receive a route comprising:
an indication of a grade for a plurality of route-segments;
an indication of a load for the plurality of route-segments; and
an indication of a distance for the plurality of route-segments; and
determine, for each of the plurality of route-segments, a route plan comprising the first consumption rate and the second consumption rate such that:
a summation of the first emissions output and the second emissions output for a first portion of the plurality of route-segments exceeds the emissions target; and
a summation of the first emissions output and the second emissions output for the route plan does not exceed the emissions target.

6. The controller of claim 1, further configured to:
receive the emissions target from a second controller communicatively connected to a plurality of vehicles comprising the vehicle, the second controller configured to:
determine, based on a total emissions target for the plurality of vehicles, the emissions target for the vehicle and a second emissions target for a second vehicle of the plurality of vehicles; and
provide the emissions target to the vehicle, and the second emissions target to the second vehicle.

7. The controller of claim 1, wherein:
the first energy source comprises a conductive element exterior to the vehicle for one or more route-segments of a route; and
the controller is configured to receive, from the conductive element, a quantity of electrical energy during the one or more route-segments.

8. The controller of claim 1, wherein:
the first energy source comprises an on-board fuel; and
the controller is further configured to:
detect a current state of fill of the on-board fuel;
compare the current state of fill to a predefined state of fill; and
select the first consumption rate and the second consumption rate based on the comparison of the current state of fill to the predefined state of fill.

9. The controller of claim 8, further configured to select the first consumption rate and the second consumption rate to extend a distance traveled between refueling.

10. The controller of claim 9, further configured to:
discretize the distance traveled into one or more positions along a route to refuel the on-board fuel; and
the extension of the distance terminates at one of the one or more positions.

11. The controller of claim 1, further configured to select the first consumption rate and the second consumption rate, based on a remaining fuel level of the first energy source, to extend a time of operation for the vehicle.

12. The controller of claim 1, further configured to:
select, based on the emissions target, a fuel blend ratio between a plurality of mixable fuels, the plurality of mixable fuels comprising:
a first fuel having a first carbon-intensity; and
a second fuel having a second carbon-intensity less than the first carbon-intensity.

13. The controller of claim 1, further configured to:
receive an indication of an unavailability of the first energy source;
select, based on the emissions target, a consumption rate of zero for the first energy source; and
select, based on the emissions target, a non-zero consumption rate for the second energy source.

14. The controller of claim 1, further configured to:
receive an indication of a source of the first energy source; and
select the first consumption rate based on the source.

15. The controller of claim 1, further configured to:
select the first emissions output for the first energy source based on the first energy source being a hydrocarbon fuel; and
select the second emissions output for the second energy source based on the second energy source being a battery.

16. A method for vehicle energy source selection, the method comprising:
determining a current state of fill of a fuel;
receiving an indication of an emissions target for a vehicle, the vehicle comprising one or more energy conversion devices configured to generate mechanical movement from a plurality of energy sources comprising the fuel;
receiving an indication of an emissions output for each of the plurality of energy sources; and
adjusting, based on the emissions target, the current state of fill, and the emissions output for each of the plurality of energy sources, a consumption rate of the fuel.

17. The method of claim 16, further comprising:
determining a second consumption rate of a second fuel of the plurality of energy sources based on the emissions target, a state of fill of the second fuel, and a second emissions output for the second fuel; and
determining a third consumption rate of electrical energy of a battery based on a state of charge (SoC) of the battery, wherein the adjustment to the consumption rate of the fuel is based on the second consumption rate and the third consumption rate.

18. The method of claim 17, further comprising:
determining the consumption rate of the fuel, the second consumption rate of the second fuel, and the third consumption rate of the electrical energy according to a local minimum of an objective function.

19. The method of claim 16, further comprising:
adjusting the consumption rate of the fuel based on a target life for the one or more energy conversion devices.

20. A system for energy source selection comprising:
a controller comprising one or more processors coupled with memory, the controller couplable with an energy conversion device of a vehicle, the energy conversion device configured to generate mechanical movement from a plurality of fuels wherein the controller is configured to:
receive an indication of an emissions target for the vehicle;
receive an indication of a first emissions output corresponding to a first fuel of the plurality of fuels and a second emissions output corresponding to a second fuel of the plurality of fuels; and
execute an objective function to select, based on the emissions target, the first emissions output, the second emissions output, and an operating parameter of the vehicle, a first consumption rate for the first fuel and a second consumption rate for the second fuel, wherein the operating parameter of the vehicle correlates negatively with a third emissions output for the vehicle.
